(19) United States
(12) Patent Application Publication
(10) Pub. No.: US 2021/0122114 A1
(43) Pub. Date: Apr. 29, 2021

(54) POWDER DEPOSITION

(71) Applicant: THE UNIVERSITY OF MANCHESTER, Manchester, Greater Manchester (GB)

(72) Inventors: Lin Li, Manchester, Greater Manchester (GB); Chao Wei, Manchester, Greater Manchester (GB); Xiaoji Zhang, Manchester, Greater Manchester (GB); Yuan-Hui Chueh, Manchester, Greater Manchester (GB)

(21) Appl. No.: 17/252,708

(22) PCT Filed: Jun. 28, 2019
(86) PCT No.: PCT/GB2019/051854

§ 371 Date: Dec. 15, 2020

(30) Foreign Application Priority Data
Jun. 29, 2018 (GB) 1810721.9

(51) Int. Cl. B29C 64/329; B29C 64/153; B29C 64/209; B29C 64/255; B22F 10/28; B22F 12/52; B22F 12/53; B33Y 10/00; B33Y 30/00

(52) U.S. Cl. CPC B29C 64/329; B29C 64/153; B29C 64/209; B29C 64/255; B33Y 30/00; B22F 12/52; B22F 12/53; B33Y 10/00; B22F 10/28

(57) ABSTRACT

A powder deposition head (100) for an additive manufacturing apparatus is described. The powder deposition head (100) comprises a hopper (110) arranged to receive a powder therein. The powder deposition head (100) comprises a nozzle (120), having a passageway (122) therethrough defining an axis A and in fluid communication with the hopper (110). The powder deposition head (100) comprises a first actuator (130) arranged to, in use, vibrate the powder in the hopper (110) and thereby control, at least in part, movement of the powder in the hopper (110) towards the nozzle (120). The powder deposition head (100) comprises a second actuator (140) coupled to the nozzle (120) and arranged to, in use, vibrate the nozzle (120), at least in part, along the axis A and thereby control, at least in part, movement of the powder from the hopper (110) through the passageway (122). In this way, the powder deposition head (100) deposits, in use, the powder at a relatively more constant (i.e. uniform) deposition rate.

### FIELD

The present invention relates to powder deposition for additive manufacturing.

### BACKGROUND TO THE INVENTION

Complex, fully dense metal parts may be manufactured by Selective Laser Melting (SLM) based on additive manufacturing by layer-by-layer powder bed fusion. SLM of metallic materials is maturing. SLM of ceramic materials, such as silica, soda-lime glass and alumina, is developing. However, SLM is generally limited to printing a single material in each layer due to use of powder bed spreading techniques. Multi-material SLM, in which multiple materials are included in each layer, has many challenges including multi-material delivery, material contamination avoidance, material recycling, new software configuration considering multiple materials, varying process parameters for different materials, effects of one material on the other, and interfaces between different materials. In multiple material SLM, materials cannot be dispensed as in normal SLM powder bed spreading, because the powders need to be deposited selectively at specific locations in each layer. For such multiple material SLM applications, as well as laser metal deposition (LMD) and laser cladding application, quality of deposition of the powders may directly affect quality of the formed part. For example, variations in powder deposition rates may result in defects, for example porosity, adversely affecting the quality of the formed part.

Hence, there is a need to improve powder deposition for additive manufacturing.

### SUMMARY OF THE INVENTION

It is one aim of the present invention, amongst others, to provide a powder deposition head which at least partially obviates or mitigates at least some of the disadvantages of the prior art, whether identified herein or elsewhere. For instance, it is an aim of embodiments of the invention to provide a powder deposition head that deposits, in use, powder at a relatively more constant (i.e. uniform) deposition rate.

According to a first aspect, there is provided a powder deposition head for an additive manufacturing apparatus, comprising:

a hopper arranged to receive a powder therein;

a noozle, having a passageway therethrough defining an axis and in fluid communication with the hopper;

a first actuator arranged to, in use, vibrate the powder in the hopper and thereby control, at least in part, movement of the powder in the hopper towards the nozzle; and a second actuator coupled to the nozzle and arranged to, in use, vibrate the nozzle, at least in part, along the axis and thereby control, at least in part, movement of the powder from the hopper through the passageway.

According to a second aspect, there is provided an additive manufacturing apparatus, preferably a selective laser melting apparatus, comprising the powder deposition head according to the first aspect.

According to a third aspect, there is provided a method of controlling powder deposition using a powder deposition head, for example according to the first aspect, for additive manufacturing, comprising preferably selective laser melting, the method comprising:

vibrating the powder in the hopper and thereby controlling, at least in part, movement of the powder in the hopper towards the nozzle; and

vibrating the nozzle, at least in part, along the axis and thereby controlling, at least in part, movement of the powder from the hopper through the passageway.

### DETAILED DESCRIPTION OF THE INVENTION

According to the present invention there is provided a powder deposition head for an additive manufacturing apparatus, as set forth in the appended claims. Also provided is an additive manufacturing apparatus and a method of controlling powder deposition. Other features of the invention will be apparent from the dependent claims, and the description that follows.

According to a first aspect, there is provided a powder deposition head for an additive manufacturing apparatus, comprising:

a hopper arranged to receive a powder therein;

a nozzle, having a passageway therethrough defining an axis and in fluid communication with the hopper;

a first actuator arranged to, in use, vibrate the powder in the hopper and thereby control, at least in part, movement of the powder in the hopper towards the nozzle; and

a second actuator coupled to the nozzle and arranged to, in use, vibrate the nozzle, at least in part, along the axis and thereby control, at least in part, movement of the powder from the hopper through the passageway.

In this way, the powder deposition head deposits, in use, the powder at a relatively more constant (i.e. uniform) deposition rate.

The inventors have determined that particularly powders (i.e. granular or particulate materials) exhibiting certain characteristics, as described below, may be deposited by conventional deposition heads at a relatively non-constant (i.e. non-uniform) deposition rate, resulting in defects in an article formed by additive manufacturing. Typically, the deposition rate for such conventional deposition heads is intermittent, with time-varying deposition rates deviating from a desired deposition rate. Without wishing to be bound by any theory, it is thought that repeated transient agglomeration (i.e. aggregation, clustering) and deagglomeration of the powder (i.e. of particles comprising the powder) in the hopper, due at least in part to cohesion (for example, due to electrostatic forces) between the particles of the powder, disrupts movement of the powder in the hopper towards the nozzle in conventional powder deposition heads. For example, the particles may form bridges or domes, which subsequently collapse, and/or may consolidate, stratify and/or settle, changing flow characteristics of the powder. Furthermore, effects due to cohesion between the particles of the powder may be exacerbated in the nozzle such as due to wall effects resulting in bridging of the particles across the nozzle, typically having a relatively small diameter so as to provide localised or high resolution deposition, of conventional deposition heads. For example, a diameter of the nozzle may be in a range from 5D to 100D, where D is a size of the particles, as described below.

Particularly, the first actuator and the second actuator synergistically control deposition of the powder, such that the deposition rate is relatively more constant. The first actuator controls, at least in part, the movement, in use, of the powder in the hopper towards the nozzle, for example towards an outlet of the hopper fluidically coupled to an inlet of the nozzle, by reducing or even eliminating transient agglomeration and deagglomeration of the powder in the hopper. The second actuator controls, at least in part, movement, in use, of the powder from the hopper through the passageway (i.e. through the nozzle, from an inlet thereof to an outlet thereof) by controlling agglomeration and deagglomeration of the powder in the passageway. However, while agglomeration and deagglomeration of the powder in the hopper are undesirable, by controlling agglomeration and deagglomeration of the powder in the passageway, deposition of the powder by the powder deposition head may be controlled, for example stopped and started. Particularly, when the second actuator is not actuated, the powder in the passageway agglomerates and movement of the powder therethrough is prevented, such that deposition of the powder by the powder deposition head is stopped. By actuating the second actuator so as to deagglomerate the powder (for example, above a threshold power and/or amplitude), movement of the powder is permitted, such that deposition of the powder by the powder deposition head is started. While actuation of the second actuator continues, deposition of the powder by the powder deposition head continues. However, deposition of the powder by the powder deposition head may only continue at a relatively constant rate if movement of the powder in the hopper towards the nozzle is similarly at the relatively constant rate, as provided by the first actuator. In other words, a flow rate of the powder out of the passageway should be equal to a flow rate of the powder into the passageway (i.e. from the hopper).

Particularly problematic powders (also known as cohesive or sticky powders) may exhibit one or more of the following characteristics:

(i) a relatively small particle size D, for example, at most 50 μm, preferably at most 20 μm; and/or

(ii) a relatively wide particle size D distribution, including a non-unimodal (e.g. bimodal) particle/or a non-monodisperse (i.e. not singular particle size) size distribution and, for example wherein 090/D10 is at least 3, preferably at least 5, more preferably at least 10; and/or

(iii) a relatively low bulk density, for example, at most 2,000 kgm⁻³, preferably at most 1,000 kgm⁻³, more preferably at most 500 kgm⁻³; and/or

(iv) a relatively high angle of repose, for example, at least 30°, more preferably at least 40°; and/or

(v) a relatively high powder anisotropy so that stresses in the powder are not equal in all directions and/or relatively high friction so that shear stresses in the powder may be proximal walls.

Generally, the angle of repose, or critical angle of repose, of a powder is the steepest angle of descent or dip relative to the horizontal plane to which the powder may be piled without slumping or sliding. The particle morphology affects, at least in part, the angle of repose, with smoother and/or more spherical particles resulting in lower angles of repose than rougher and/or less spherical particles. Liquid, flow additives (such as for example magnesium stearate or sodium dodecyl sulphate), or lubricant additions may affect angles of repose by affecting interparticle interactions.

In more detail, flow of powders from hoppers, for example, may exhibit one of two different flow patterns: core-flow or mass-flow. Core-flow is a default flow pattern, in which powder discharge is through a preferential flow channel that forms in the powder above the draw down point of the outlet. Powder is drawn into the flow channel from the top free surface, giving a first-in, last-out discharge (i.e. deposition) behaviour. If operated in a continuous mode (c.f. a batch mode), the powder around the walls in the lower section remain static in the hopper (i.e. dead volumes) until the hopper has nearly emptied completely. In contrast, mass-flow is a desirable flow pattern for powders that are poor flowing or time sensitive. Typically, the hopper, at least, is designed to achieve mass-flow. In mass-flow, substantially all and preferably all the powder is subject to flow, giving a first-in, first-out discharge (i.e. deposition) behaviour. To achieve mass-flow, the hopper walls are preferably sufficiently steep and/or smooth, which may depend, at least in part, on characteristics of the powder. Fora given converging angle of the hopper walls and/or a material thereof, the powder wall friction is preferably below a threshold value, which may depend, at least in part, on characteristics of the powder. In addition, discharge of the powder is preferably controlled, for example by a valve or feeder, to allow powder to flow through the entire cross sectional area of the hopper outlet.

In more detail, there are two flow obstructions that may disturb, impede, interrupt and/or prevent powder flow: rat-holing and arching. Rat-holing predominates in core-flow, in which generally only the powder in the flow-channel above the outlet discharges, leaving an otherwise stable surrounding powder structure. Arching predominates in mass-flow, in which a relatively stable powder arch forms across the outlet or converging walls of the hopper, thereby preventing flow. For a given powder, there is a critical outlet dimension that is preferably exceeded in order to ensure reliable discharge, either in core-flow or mass-flow, being the critical rat-hole diameter Dᵣₕ and the critical arching diameter D_{c} or Dₚ (depending on the hopper geometry), respectively. Generally, for a given powder, the rat-hole critical rat-hole diameter Dᵣₕ is greater than the critical arching diameter D_{c} or Dₚ.

There are a number of methods for measuring particle size, which give generally comparable results. For the avoidance of doubt however, in case of ambiguity, the term “particle size” as used herein is intended to refer to measurements made according to ASTM B822-02.

The powder deposition head is for an additive manufacturing apparatus, for example a selective laser melting (SLM) additive manufacturing apparatus, a laser metal deposition (LMD) apparatus and/or a laser cladding apparatus.

The powder deposition head comprises the hopper arranged to receive the powder therein. In one example, the hopper comprises an outlet in fluid communication with the passageway. In one example, the outlet is fluidically coupled to the passageway via a flexible, for example an elastomeric, tube. In this way, the nozzle and the hopper may be vibrationally mutually isolated and/or dampened such that vibrations due to the first actuator are reduced at the nozzle and/or vibrations due to the second actuator are reduced at the hopper. In one example, the hopper comprises a wall portion inclined to the axis, forming a funnel towards the outlet. In one example, an angle of inclination of the wall portion is at least an angle of repose of the powder. In one example, the angle of inclination is at least 40°, preferably at least 50°, more preferably at least 60°. In one example, the hopper comprises and/or is a conical hopper. In one example, the hopper comprises and/or is a wedge (also known as a plane) hopper. Conical hoppers are preferred. In one example, the hopper is arranged to exhibit mass-flow of the powder. In this way, dead volumes of the powder are avoided and/or a different powder may be received in the hopper without requiring cleaning of the hopper, so as to avoid mixing.

In one example, the hopper is arranged to receive the powder therein (i.e. has a capacity, for example a maximum capacity) in a range from 1 g to 100 g, preferably in a range from 1 g to 50 g. That is, the capacity of the hopper is relatively small.

The powder deposition head comprises the nozzle, having the passageway therethrough defining the axis and in fluid communication with the hopper. It should be understood that in use, the passageway and hence the axis is oriented vertically or substantially vertically, such that the movement of the powder from the hopper through the passageway is due, at least in part, to gravitational forces acting on the powder.

In one example, the passageway has a diameter in a range from 0.1 mm to 1.0 mm, preferably from 0.2 mm to 0.8 mm, more preferably from 0.3 mm to 0.5 mm. In one example, the passageway has a diameter in a range from 5 D to 100 D, where D is a size of the particles. In this way, localised or high resolution deposition of the powder may be provided.

The powder deposition head comprises the first actuator arranged to, in use, vibrate the powder in the hopper and thereby control, at least in part, movement of the powder in the hopper towards the nozzle. In this way, as described above, obstructions in the hopper may be prevented, thereby improving flow of the powder therethrough. It should be understood that the first actuator comprises and/or is a vibrator or an oscillator, for example.

In one example, the first actuator is coupled to the hopper. In one example, the first actuator is coupled to a wall, for example a wall portion, of the hopper, for example directly coupled thereto. Vibrations from the first actuator may be thus transmitted through the wall of the hopper and hence into the powder. In this way, cohesion of the powder to the wall of the hopper, for example, may be overcome while additionally and/or alternatively, disrupting obstructions that form in the powder.

In one example, the first actuator is within the hopper, for example at least partly within and/or fully within. Vibrations from the first actuator may be thus transmitted directly into the powder.

In this way, obstructions that form in the powder may be disrupted. In one example, the first actuator is within the hopper, proximal an outlet thereof. In this way, obstructions that form in the powder proximal the outlet may be disrupted. Since a cross-sectional dimension, for example, of the outlet is typically smaller than that of the hopper, obstructions may tend to form proximal and/or at the outlet.

In one example, the first actuator is arranged to vibrate, at least in part, transverse, preferably orthogonal, to the axis. In other words, since, in use, the passageway and hence the axis is oriented vertically or substantially vertically, the first actuator is arranged to vibrate in a horizontal plane or substantially in a horizontal plane. The inventors have determined that such transverse vibration due to the first actuator may be effective in disrupting obstructions that form in the powder while not interfering with control, at least in part, of the movement of the powder from the hopper through the passageway due to the second actuator.

In one example, the first actuator is arranged to vibrate in a frequency range from 20 Hz to 10 GHz.

In one example, the first actuator is arranged to vibrate in a frequency range from 20 kHz to 10 GHz, preferably from 20 kHz to 50 kHz. In one example, the first actuator comprises and/or is a piezoelectric transducer, arranged to vibrate in a frequency range from 20 kHz to 10 GHz, preferably from 20 kHz to 50 kHz. Generally, piezoelectric transducers are a type of electroacoustic transducer that convert electrical charges produced by some forms of solid materials into energy.

In one example, the first actuator comprises and/or is a piezoelectric transducer, arranged to vibrate in a frequency range from 20 kHz to 10 GHz, preferably from 20 kHz to 50 kHz, to vibrate, at least in part, transverse, preferably orthogonal, to the axis and is coupled to the hopper.

In one example, the first actuator is arranged to vibrate in a frequency range from 20 Hz to 20 kHz, preferably from 100 Hz to 10 kHz. In one example, the first actuator comprises and/or is a vibration motor, for example an eccentric rotating mass vibration motor (ERM) that includes a small unbalanced mass on a DC motor or a linear resonant actuator (LRA) that includes a small internal mass attached to a spring. Suitable vibration motors are available from Precision Microdrives Limited (UK), for example. Typically, such vibration motors operate at a voltage in a range from 3 V to 5 V DC, a current in a range from 30 mA, a rotational speed in a range from 8000 rμm to 24000 rμm and providing a torque in a range from 0.3 g.cm to 3.0 g.cm.

In one example, the first actuator comprises and/or is a vibration motor, preferably an ERM, arranged to vibrate in a frequency range from 20 Hz to 20 kHz, preferably from 100 Hz to 10 kHz, to vibrate, at least in part, transverse, preferably orthogonal, to the axis and is within the hopper.

In one example, the first actuator is arranged to vibrate with an amplitude in a range from 0.1 μm to 500 μm. In one example, the first actuator comprises and/or is a piezoelectric transducer arranged to vibrate with an amplitude in a range from 0.1 μm to 50 μm. In one example, the first actuator comprises and/or is a vibration motor arranged to vibrate with an amplitude in a range from 1 μm to 500 μm.

The powder deposition head comprises the second actuator coupled to the nozzle and arranged to, in use, vibrate the nozzle, at least in part, along the axis and thereby control, at least in part, movement of the powder from the hopper through the passageway, as described previously.

In one example, the second actuator is arranged to vibrate in a frequency range from 20 kHz to 10 GHz, preferably from 20 kHz to 50 kHz. In one example, the second actuator comprises and/or is a piezoelectric transducer, arranged to vibrate in a frequency range from 20 kHz to 10 GHz, preferably from 20 kHz to 50 kHz. Generally, piezoelectric transducers are a type of electroacoustic transducer that convert electrical charges produced by some forms of solid materials into energy.

In one example, the first actuator and the second actuator are arranged to vibrate in phase. In one example, the first actuator and the second actuator are arranged to vibrate out of phase.

For example, the frequencies of vibration and/or timings of the first actuator and the second actuator may be controlled such that the first actuator and the second actuator vibrate in phase or out of phase, as required. The inventors have determined that such out of phase vibration may be effective in disrupting obstructions that form in the powder while not interfering with control, at least in part, of the movement of the powder from the hopper through the passageway due to the second actuator.

In one example, the first actuator and the second actuator are arranged to vibrate such that the respective vibrations constructively interfere. For example, the relative positions and/or orientations of the first actuator and the second actuator may be selected such that constructive interference occurs within the hopper, thereby more effectively disrupting obstructions therein.

In one example, the first actuator and the second actuator are at least partly mutually vibrationally isolated such that the respective vibrations are mutually dampened, for example by vibrationally isolating the first actuator and the second actuator using a flexible, for example, elastomeric component. In this way, actuation of the first actuator may be continuous while starting and stopping of the deposition using the second actuator is unaffected by vibrations due to the first actuator. Alternatively, actuation of the second actuator may be synchronised with that of the first actuator, for example the first actuator and the second actuator may be started and stopped simultaneously.

In one example, the powder deposition head comprises a powder reservoir in fluid communication with the hopper and vibrationally isolated therefrom, wherein the powder reservoir is arranged to replenish the powder in the hopper. The inventors have determined that the rate of deposition of the powder may be due, at least in part, to an amount or head of the powder in the hopper. Hence, by replenishing the powder in the hopper, the amount or the head of the powder in the hopper may be maintained more constant, resulting in a more constant rate of deposition of the powder while the amount of the powder in the hopper remains relatively small, as described previously. By vibrationally isolating the powder reservoir from the hopper, vibrational energy from the first actuator, for example, is not dissipated through to the powder reservoir. In one example, the powder reservoir comprises a flexible conduit, for example a polymeric and/or elastomeric tube, having an end arranged proximal to and spaced apart from a surface of the powder in the hopper, thereby vibrationally isolating the powder reservoir from the hopper.

In one example, the powder reservoir comprises a syringe arranged to replenish the powder in the hopper. In one example, the syringe is pneumatically actuated. In one example, a rate of actuation of the syringe is controlled to replenish the powder in the hopper at the same rate as the rate of deposition of the powder by the powder deposition head.

In one example, the powder deposition head comprises an actuatable member, coupled to the first actuator, arranged to extend towards and/or at least partially into the passageway, for example proximal an outlet (i.e. tip) of the nozzle. In this way, agglomeration of the powder in the nozzle tip is reduced.

According to a second aspect, there is provided an additive manufacturing apparatus, preferably a selective laser melting apparatus, comprising the powder deposition head according to any previous claim.

According to a third aspect, there is provided a method of controlling powder deposition using a powder deposition head, for example according to the first aspect, for additive manufacturing, comprising preferably selective laser melting, the method comprising: vibrating the powder in the hopper and thereby controlling, at least in part, movement of the powder in the hopper towards the nozzle; and vibrating the nozzle, at least in part, along the axis and thereby controlling, at least in part, movement of the powder from the hopper through the passageway.

In one example, the powder has a bulk density in a range from 50 kg/m³ to 5000 kg/m³, preferably from 250 kg/m³ to 2500 kg/m₃.

It should be understood that the powder comprises particles that are solid and may include discrete and/or agglomerated particles. In one example, the particles have an irregular shape, such as a spheroidal, a flake or a granular shape.

Generally, the powder may comprise any material amenable to fusion by melting, such as metals or polymeric compositions. The powder may comprise a metal, such as aluminium, titanium, chromium, iron, cobalt, nickel, copper, tungsten, silver, gold, platinum and/or an alloy thereof. Generally, the powder may comprise any metal from which particles may be produced by atomisation. These particles may be produced by atomisation, such as gas atomisation or water atomisation, or other processes known in the art. These particles may have regular, such as spherical, shapes and/or irregular, such as spheroidal, flake or granular, shapes. The powder may comprise a polymeric composition comprising a polymer, for example, a thermoplastic polymer. The thermoplastic polymer may be a homopolymer or a copolymer. The thermoplastic polymer may be selected from a group consisting of poly(methyl methacrylate) (PMMA), acrylonitrile butadiene styrene (ABS), aliphatic or semi-aromatic polyamides, polylactic acid (polylactide) (PLA), polybenzimidazole (PBI), polycarbonate (PC), polyether sulfone (PES), polyetherimide, polyethylene (PE), polypropylene (PP), polymethylpentene (PMP) and polybutene-1 (PB-1), polystyrene (PS) and polyvinyl chloride (PVC). The powder may comprise a ceramic, for example a refractory material, sand, SiO₂, SiC, Al₂O₃, Si₂N₃, ZrO₂, Ceramic particles may have regular, such as spherical, cuboidal or rod, shapes and/or irregular, such as spheroidal, flake or granular, shapes (also known as morphologies).

These particles may have a size of at most 200 μm, at most 150 μm, at most 100 μm, at most 75 μm, at most 50 μm, at most 25 μm, at most 15 μm, at most 10 μm, at most 5 μm, or at most 1 μm. These particles may have a size of at least 150 μm, at least 100 μm, at least 75 μm, at least 50 μm, at least 25 μm, at least 15 μm, at least 10 μm, at least 5 μm, or at least 1 μm. Preferably, these particles have a size in a range 10 μm to 200 μm. More preferably, these particles have a size in a range 60 μm to 150 μm. In one example, the powder comprises particles having a size in a range from 5 μm to 200 μm, preferably from 60 μm to 150 μm.

For regular shapes, the size may refer to the diameter of a sphere or a rod, for example, or to the side of a cuboid. The size may also refer to the length of the rod. For irregular shapes, the size may refer to a largest dimension, for example, of the particles. Suitably, the particle size distribution is measured by use of light scattering measurement of the particles in an apparatus such as a Malvern Mastersizer 3000, arranged to measure particle sizes from 10 nm to 3500 micrometres, with the particles wet-dispersed in a suitable carrier liquid (along with a suitable dispersant compatible with the particle surface chemistry and the chemical nature of the liquid) in accordance with the equiμment manufacturer's instructions and assuming that the particles are of uniform density. Suitably, the particle size distribution is measured according to ASTM B822-02.

In one example, the particles have a relatively small particle size D, for example, at most 50 μm, preferably at most 20 μm. In one example, the particles have a relatively wide particle size D distribution, including a non-unimodal (e.g. bimodal) particle/or a non-monodisperse (i.e. not singular particle size) size distribution and, for example wherein D90/D10 is at least 3, preferably at least 5, more preferably at least 10). In one example, the particles have a relatively low bulk density, for example, at most 2,000 kgm⁻³, preferably at most 1,000 kgm⁻³, more preferably at most 500 kgm⁻³. In one example, the particles have a relatively high angle of repose, for example, at least 30°, more preferably at least 40°. In one example, the particles have a relatively high powder anisotropy so that stresses in the powder are not equal in all directions and/or relatively high friction so that shear stresses in the powder may be proximal walls.

The powder may comprise an additive, an alloying addition, a flux, a binder and/or a coating. The powder may comprise particles having different compositions, for example a mixture of particles having different compositions.

It should be understood that unalloyed metals refer to metals having relatively high purities, for example at least 95 wt. %, at least 97 wt. %, at least 99 wt. %, at least 99.5 wt. %, at least 99.9 wt. %, at least 99.95 wt. %, at least 99.99 wt. %, at least 99.995 wt. % or at least 99.999 wt. % purity.

In one example, the powder comprises a metal. In one example, the metal is a transition metal, for example a first row, a second row or a third row transition metal. In one example, the metal is Sc, Ti, V, Cr, Mn, Fe, Co, Ni, Cu or Zn. In one example, the metal is Y, Zr, Nb, Mo, Tc, Ru, Rh, Pd, Ag or Cd. In one example, the metal is Hf, Ta, W, Re, Os, Ir, Pt, Au or Hg.

Inorganic compounds such as ceramics comprising the metal may include, for example, oxides, silicates, sulphides, sulphates, halides, carbonates, phosphates, nitrides, borides, carbides, hydroxides of the metal.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 schematically depicts a powder deposition head according to an exemplary embodiment; and

FIG. 2 schematically depicts the powder deposition head of FIG. 1, in more detail;

FIG. 3 schematically depicts the powder deposition head of FIG. 1, in more detail;

FIG. 4 shows optical micrographs of (A) 316L stainless steel powder; and (B) bi-modal soda lime glass powder;

FIG. 5 schematically depicts powder dropping from the powder deposition head of FIG. 1 from (A) a hopper; and (B) a nozzle;

FIG. 6 shows a graph of powder flow (g) as a function of time (s) for a conventional powder deposition head;

FIG. 7 shows a graph of powder flowrate as a function of actuator power for 316L stainless steel powder and soda lime glass powder for the powder deposition head of FIG. 1;

FIG. 8 shows a graph of powder flow (g) as a function of time (s) for the powder deposition head of FIG. 1 having a 0.2 mm orifice for 316L stainless steel powder at a power of (A) 6 W; (B) 24 W; (C) 42 W; and (D) 60 W;

FIG. 9 shows a graph of powder flow (g) as a function of time (s) for the powder deposition head of FIG. 1 having a 0.3 mm orifice for 316L stainless steel powder at a power of (A) 6 W; (B) 24 W; (C) 42 W; and (D) 60 W;

FIG. 10 shows a graph of powder flow (g) as a function of time (s) for the powder deposition head of FIG. 1 having a 0.3 mm orifice for soda lime glass powder at a power of (A) 6 W; (B) 24 W; (C) 42 W; and (D) 60 W;

FIG. 11 shows a graph of powder flow (g) as a function of time (s) for the powder deposition head of FIG. 1 having a 0.35 mm orifice for soda lime glass powder at a power of (A) 6 W; (B) 24 W; (C) 42 W; and (D) 60 W;

FIG. 12 shows photographs of powder flows for the powder deposition head of FIG. 1 for (A) a smaller orifice diameter and a higher power; and (B)) a larger orifice diameter and a smaller power;

FIG. 13 schematically depicts an inclined single track test for powder deposition using the powder deposition head of FIG. 1;

FIG. 14 shows a graph of line height (μm) as a function of stand-off distance (μm) for 316L stainless steel powder for the inclined single track test of FIG. 13;

FIG. 15 shows for region A for 316L stainless steel powder for the inclined single track test of FIG. 13 (A) a micrograph; and (B) a cross section of the deposited powder along the arrow shown in (A);

FIG. 16 shows for region B for 316L stainless steel powder for the inclined single track test of FIG. 13 (A) a micrograph; and (B) a cross section of the deposited powder along the arrow shown in (A);

FIG. 17 shows for region C for 316L stainless steel powder for the inclined single track test of FIG. 13 (A) a micrograph; and (B) a cross section of the deposited powder along the arrow shown in (A);

FIG. 18 shows a graph of line height (μm) as a function of stand-off distance (μm) for soda lime glass powder for the inclined single track test of FIG. 13;

FIG. 19 shows a micrograph of initial deposition of soda lime glass powder for the inclined single track test of FIG. 13;

FIG. 20 shows for region A for soda lime glass powder for the inclined single track test of FIG. 13 (A) a micrograph; and (B) a cross section of the deposited powder along the arrow shown in (A);

FIG. 21 shows for region B for soda lime glass powder for the inclined single track test of FIG. 13 (A) a micrograph; and (B) a cross section of the deposited powder along the arrow shown in (A);

FIG. 22 shows for region C for soda lime glass powder for the inclined single track test of

FIG. 13 (A) a micrograph; and (B) a cross section of the deposited powder along the arrow shown in (A);

FIG. 23 schematically depicts line forming mechanisms for the regions A, B and C for the inclined single track test of FIG. 13;

FIG. 24 schematically depicts layer forming mechanisms for the regions B and C for the inclined single track test of FIG. 13;

FIG. 25 shows photographs of powder lines deposited at speeds of 1000 mm per minute, 2000 mm per minute and 3000 mm per minute for (A) 316L stainless steel powder; and (B) soda lime glass powder;

FIG. 26 shows a bar chart of line width (μm) as a function of scanning speed for 316L stainless steel powder and soda lime glass powder using the powder deposition head of

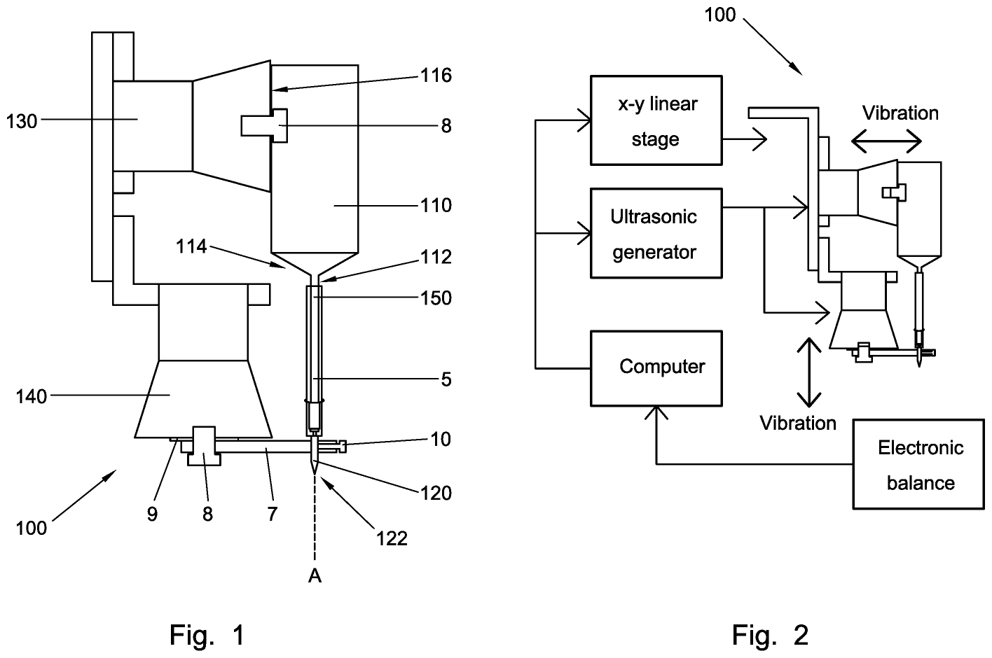

FIG. 1;

FIG. 27 shows a photograph of a pattern, including the letters ‘LPRC’, formed from 316L stainless steel (outside) and soda lime glass (inside) using the powder deposition head of FIG. 1;

FIG. 28 shows a 50 mm×50 mm single layer powder deposited using the powder deposition head of FIG. 1 for (A) 316L stainless steel; and (B) soda lime glass;

FIG. 29 shows micrographs of a twenty layer 5 mm by 5 mm rectangular block of soda lime glass formed by SLM using the powder deposition head of FIG. 1 on a 1 mm thick 316L stainless steel substrate formed by SLM using the powder deposition head of FIG. 1 (A) surface; and (B) head affected zone (HAZ);

FIG. 30 shows a micrograph of a cross section of the block shown in FIG. 29;

FIG. 31 shows a micrograph of channels, having widths of 3 mm and 6 mm respectively, formed by SLM of 316L stainless steel powder using the powder deposition head of FIG. 1 (A) cross section; and (B) plan view;

FIG. 32 shows micrographs of interfaces between 316L stainless steel and soda lime glass formed by SLM using the powder deposition head of FIG. 1 (A) plan view; and (B) at an angle of 60°;

FIG. 33 shows a micrograph of the cross section of the interface between 316L stainless steel and soda lime glass, having a width of 3 mm, of FIG. 32, in more detail;

FIG. 34 shows a micrograph of 2 mm deep channels, having widths of 3 mm and 6 mm respectively, formed by SLM of 316L stainless steel powder using the powder deposition head of FIG. 1 and filled with soda lime glass formed by SLM of 316L stainless steel powder using the powder deposition head of FIG. 1;

FIG. 35 shows (A) a photograph of a pendant formed by SLM of 316L stainless steel powder using the powder deposition head of FIG. 1 and filled with soda lime glass formed by SLM of 316L stainless steel powder using the powder deposition head of FIG. 1; and (B) the pendant in more detail;

FIG. 36 schematically depicts a powder deposition head according to an exemplary embodiment; and

FIG. 37 schematically depicts the powder deposition head of FIG. 36, in more detail;

FIG. 38 schematically depicts a selective laser melting apparatus including the powder deposition head of FIG. 36;

FIG. 39 schematically depicts a method of selective laser melting using the apparatus of FIG. 38;

FIG. 40 shows a) SEM micrograph of 320 grit SiC powder, b) SEM micrograph of 600 grit SiC powder, c) SEM micrograph of SiC-316L composite powder with 320 grit SiC powder;

FIG. 41 shows a) a schematic diagram of a cross section of a sandwich sample, b) a sample with a grid transition layer between the 316L part and SiC-316L part, c) a cross section pattern of the transition layer;

FIG. 42 shows test specimens produced by SLM for density comparison, a) made of SiC-316L composite with 25 vol. % SiC, b) 40 vol. % SiC, c) 50 vol. % SiC;

FIG. 43 shows optical images of the 316L/SiC composite after laser processing. a) an optical microscopic image of microstructure of the laser sintered specimen D3 with 25 vol. % SiC additive, b) specimen D3 with 40 vol. % SiC. The laser processing parameters for both specimens were the same: laser power 175 W, scanning speed 800 mm/s, hatch distance 60 μm;

FIG. 44 shows graphs of mean of relative density as functions of laser power, scanning speed and hatch distance;

FIG. 45 shows a graph showing relative densities of SLM processed SiC-316L specimens as the increasing of the laser track overlap;

FIG. 46 shows a graph of relative density of the SLM processed SiC-316L samples with increasing laser energy density;

FIG. 47 shows a graph of deposited pure 320 grit SiC powder weight as time increasing;

FIG. 48 shows photographs of powder flow angles a) pure 320 grit SiC powder flow dispensed by the hybrid vibration, b) pure 320 grit SiC powder flow dispensed by the ultrasonic vibration alone without the motor vibration;

FIG. 49 shows a graph of change of total volumes of the SiC-316L composite after mixing with the volume fraction of the SiC additive;

FIG. 50 shows a) a schematic of the matrix material powder distribution, b) gaps between the matrix powder filled by the small additive material particles;

FIG. 51 shows graphs of deposited powder volume as a function of time, particularly power deposition volume over time under different material configurations a) plot of all results of deposited powder volume to time, b) relationship between deposited powder volume and time as the variation of the 320 gird SiC volume fraction, c) relationship between deposited powder volume and time as the variation of the 600 gird SiC volume fraction, d) to f) comparison of the 320 grit SiC and 600 grit SiC composite depositing flow rate at the equal volume fraction, including 25 vol. %, 40 vol. % and 50 vol. %;

FIG. 52 shows a) Optical microscopic graph of the material interface between 316L building material and SiC-316L support material, b) A magnified view of material interface with cavities and pores due to SiC particles falling off during the specimen grinding, c) an SEM image of the internal view of such cavity;

FIG. 53 shows a) XRD result of the bottom surface of the 316L layer near the SiC-316L composite support, b) XRD result of the top surface of the 316L layer;

FIG. 54 shows a) and b) microscopy images of the 316L part bottom adhered to the SiC-316L composite support structure before and after sand blasting respectively, c) The overall look of the sample with the grid transition layer, d) and e) microscopy images of the grid lines on the bottom surface of the 316L part before and after sand blasting respectively;

FIG. 55 shows a) XRD result of the 316L part bottom surface (that was in contact with the support material) after sand blasting, b) XRD result of the grid lines on the bottom surface of the 316L part after sand blasting;

FIG. 56 shows photographs of a) a bridge structure using SiC-316L as the support material at the aperture position, b) shows the support structure removed, c) demonstrates a laser fused cross section of the bridge structure;

FIG. 57 shows a) The 3D model of a double helix, b) an image of SLM processed double helix with cracks along the material interface;

FIG. 58 shows a) SEM image of the material interface on the top surface of the double helix, b) to d) are EDS maps of the material interface on the top surface of the double helix;

FIG. 59 schematically depicts a powder reservoir for a powder deposition head according to an exemplary embodiment;

FIG. 60 schematically depicts an additive manufacturing apparatus 30 for use with a powder deposition head according to an exemplary embodiment;

FIG. 61 schematically depicts a powder deposition head according to an exemplary embodiment;

FIG. 62 shows photographs of powders that may be deposited using the powder deposition head of FIG. 61. Polymer and reinforcement powders used: (A) PAll Nylon powder (B) Aluminium oxide powder (C) soda-line glass powder (D) Cu10Sn copper alloy powder;

FIG. 63 shows photographs of Cu10Sn/PA11 upward functionally graded materials (FGM) provided using the powder deposition head of FIG. 61;

FIG. 64 shows photographs of Cul10Sn/PA11 lateral functionally graded materials (FGM) provided using the powder deposition head of FIG. 61;

FIG. 65 shows photographs of 80% Cu10Sn—20% PAll and 30% A1203—70% PAll functionally graded materials (FGM) provided using the powder deposition head of FIG. 61; and

FIG. 66 shows A) design of the multiple functional turbine blades, B) powder distribution during the printing process, C&D) 3D printed multiple functional motor blades, E) 3-D functionally graded structure, F) a curved metal/polymer structure, provided using the powder deposition head of FIG. 61.

### DETAILED DESCRIPTION OF THE DRAWINGS

### Embodiment 1

### Experimental

### Powder Deposition Head

In order to deliver additional materials on the same layer selectively, a dual ultrasonic point-by-point powder dispensing system (i.e. a powder deposition head 100) was designed and integrated to an in-house SLM system (shown in FIG. 60). The structure of the dual ultrasonic powder delivery system (i.e. the powder deposition head 100) is shown in FIGS. 1 to 3 and Table 1.

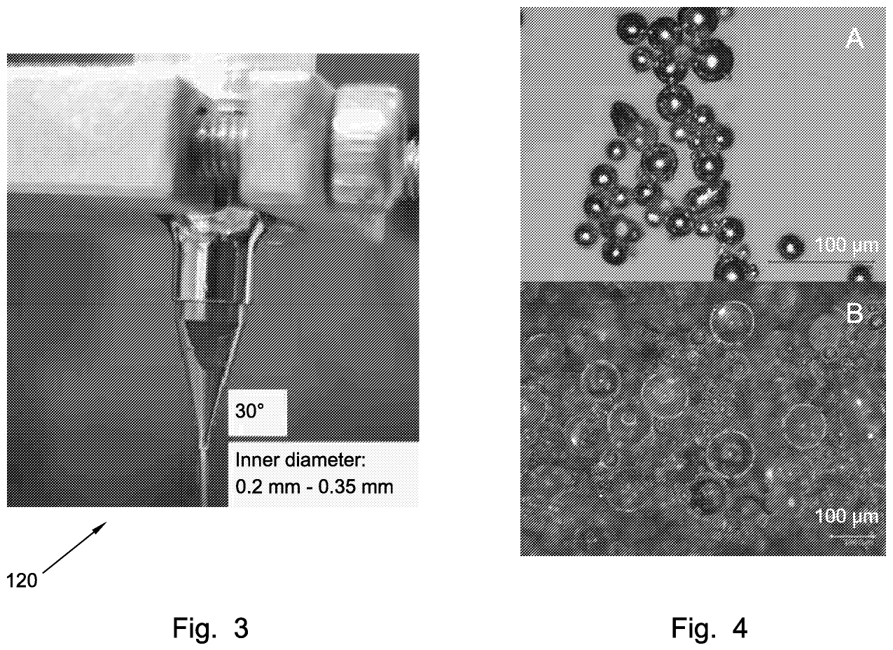

FIG. 1 schematically depicts the powder deposition head 100 according to an exemplary embodiment. FIG. 2 and FIG. 3 schematically depict the powder deposition head 100 of FIG. 1, in more detail.

Particularly, the powder deposition head 100 is for an additive manufacturing apparatus. The powder deposition head 100 comprises a hopper 110 arranged to receive a powder therein. The powder deposition head 100 comprises a nozzle 120, having a passageway 122 therethrough defining an axis A and in fluid communication with the hopper 110. The powder deposition head 100 comprises a first actuator 130 arranged to, in use, vibrate the powder in the hopper 110 and thereby control, at least in part, movement of the powder in the hopper 110 towards the nozzle 120. The powder deposition head 100 comprises a second actuator 140 coupled to the nozzle 120 and arranged to, in use, vibrate the nozzle 120, at least in part, along the axis A and thereby control, at least in part, movement of the powder from the hopper 110 through the passageway 122.

In this way, the powder deposition head 100 deposits, in use, the powder at a relatively more constant (i.e. uniform) deposition rate.

The powder deposition head comprises the hopper 110 arranged to receive the powder therein. In this example, the hopper 110 comprises an outlet 112 in fluid communication with the passageway 122. In this example, the hopper 110 comprises a first wall portion 114 inclined to the axis A, forming a funnel towards the outlet 112. In this example, an angle of inclination of the wall portion 114 is at least an angle of repose of the powder. In this example, the angle of inclination is 30°. In this example, the hopper 110 is a conical hopper. In this example, the hopper 110 has a capacity of 50 g. That is, the capacity of the hopper 110 is relatively small. In this example, the outlet 112 is fluidically coupled to the passageway 122 via a flexible tube 150. In this example, the passageway 122 has a diameter in a range from 0.2 mm to 0.35 mm.

In this example, the first actuator 130 is coupled to the hopper 110. In this example, the first actuator is directly coupled to a second wall portion 116 of the hopper, using a M10 screw with anti-slip washer 8. In this example, the first actuator 130 is arranged to vibrate, at least in part, orthogonal to the axis A. In this example, the first actuator 130 is a piezoelectric transducer arranged to vibrate at a frequency of 28 kHz. In this example, the first actuator 130 is a piezoelectric transducer arranged to vibrate with an amplitude in a range from 0.1 μm to 50 μm.

In this example, the second actuator 140 is a piezoelectric transducer arranged to vibrate at a frequency of 28 kHz.

TABLE 1
List of components of the ultrasonic vibration feeding system
(i.e. the powder deposition).

| No. | Component | No. | Component |
|---|---|---|---|
| 130 | Upper PZT | 120 | Needle/nozzle |
| 140 | Lower PZT | 7 | Bracket |
| 110 | Hopper | 8 | M10 screw with anti-slip washer |
| 150 | Soft tube | 9 | Insulation rubber washer |
| 5 | Joint | 10 | M3 screw for fixing the needle |

Two standard piezoelectric transducers (PZT) at a 28 kHz vibration frequency, a maximum 60 W vibration power which are widely used in ultrasonic cleaning, were used. Dimensions of the PZT are 67 mm in height. The 59 mm diameter of the actuator surface could deliver vibration evenly. As shown in FIG. 1, the lower ultrasonic transducer provided vertical vibrations to the delivery nozzle (made of a stainless steel surgical needle) with a very small orifice diameter (0.2 mm-0.35 mm in this particular experiment). An aluminium bracket was tightly fixed to the lower PZT by an M10 screw through an anti-slip washer and a rubber washer. The anti-slip washer was used for avoiding loose connection to the ultrasonic PZT and the rubber washer was used for insulating heat from the PZT to the bracket. The stainless steel surgical needle was directly fixed at the bracket (FIG. 3), so that full vibrational power can be transferred to the needle. The upper PZT horizontally vibrated a fixed 50 ml cylindrical powder hopper which had a 120° angle of the orifice and a 2 mm orifice, by which powders were dispensed to the feeding nozzle consistently.

### Materials and Methods

Spherical 316L stainless steel powders (LPW-316-AAHH, 10-45 μm, LPW Technology Ltd., UK) were selected as the candidate for metal printing in this research shown in FIG. 4A. Two sizes of spherical soda-lime powders (30±2 μm and 90±2 μm respectively, supplied by Goodfellow) were mixed in a mass weight ratio of 1:3 (smaller powder : larger powder) according to the optimal packing equation of bimodal mixtures of spheres. It is known that bimodal mixtures of spheres can improve packing density and also increase laser absorption and thermal conductivity. Ground finished 304 steel sheets of 25 mm×25 mm×12 mm in dimension were used as the supporting substrate where the laser deposited components were built on.

An x-y-z galvo scanner (Nutfield, 3XB 3-axis) was used to scan the laser beam with an 80 μm focused beam spot size generated from a 500 W ytterbium single-mode, continuous wave (CW) fibre laser (IPG Photonics, YLR-500-WC) of a 1070 nm wavelength over the target powder bed. Nitrogen gas was used for gas shield in the sealed chamber during processing. Optimised laser processing parameters on both materials are shown in Table 2.

TABLE 2
Optimised SLM parameters for 316L stainless steel and soda lime glass.

| | Power | Scanning speed | Hatch space | Scanning |
|---|---|---|---|---|
| Material | (W) | (mm/s) | (mm) | strategy |
| 316L stainless | 170 | 800 | 0.035 | Zig-zag |
| steel | | | | |
| Soda lime | 180 | 300 | 0.05 | Zig-zag |
| glass | | | | |

### Powder Obstruction and Disruption Thereof

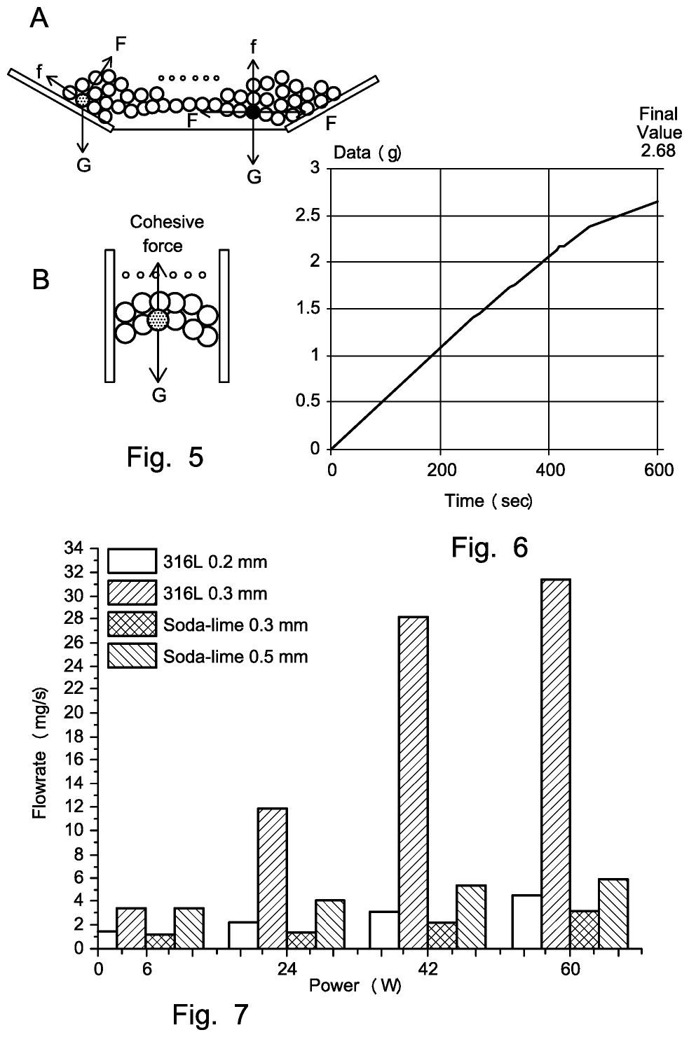

Powders can be compacted and jammed in the hopper by the counter force against the gravity of the powder from the 120° angle of the orifice of the hopper. The forces of the powder on the sidewall (e.g. the green coloured powder particle shown in FIG. 5(a)) can be described as:

$$G = F sin \frac{A O R}{2} + f cos \frac{A O R}{2} = \frac{\sqrt{3}}{2} F + \frac{1}{2} f \qquad ( 1 )$$

where G is the gravity, F is the support forces from the wall of the hopper and f is the friction force. The horizontal projection of the support forces generates frictions to the powders in the middle of the orifice (e.g. the purple powder shown in FIG. 5(a)) and make them stay. In this case, the added vertical vibration is like increasing gravity, which not only breaks the force balance, but also increases tightness of the powders, causing jamming. The horizontal vibration from the upper PZT can reduce the support forces from the sidewalls and avoid powders jamming at the orifice of the hopper. The vertical vibration from the lower PZT can provide a vertical acceleration to powders in the feeding nozzle (FIG. 5(b)), with which the attractive force between cohesive powders could be broken. A soft tube connected the hopper and the needle, so that the needle did not need to take the weight of the hopper, which can avoid the influence of the weight of powders on the powder feeding. Also the weight of powders can change the natural frequency of the system, so that resonance is disturbed. Two identical systems were mounted on an x-y linear stage inside the in-house SLM system and the motion control was programmed using G-codes. An electric balance (from Ek-300i, A&D Ltd) was used to record the powder flow weight automatically to a computer. The maximum load of the balance was 300 g and its resolution was 0.01 g.

Powder flowrate, i.e. the powder mass output through a nozzle within unit time, is an important parameter that would affect the material deposition. However, little is known about the stability of long-time powder dispensing using the ultrasonic powder dispensing systems. This can be very important in multiple material SLM additive manufacturing since the operations could be for a few hours continuously.

Material flowability, dispensing force and counterforce are the three main factors that influence material delivery. The vibrational acceleration generates the dispensing force, and the counterforce (friction) is determined by the needle/nozzle geometry and properties of the powders. Powders used were standard spherical powder materials for SLM and thus the powder size distribution and spherical shape were ideal for SLM. The powders were dried at 120 OC for 12 hours in an oven before being used. The amplitude and frequency are two main factors for the PZTs according to Matsusaka's vibrational acceleration equation:

α=A(2πf)² (2)

where a is the vibrational acceleration, A is the amplitude and f is the frequency. A constant 28 kHz frequency and average a 5 μm amplitude of 60 W (measured by the VHX-5000 microscope) were used in the experiments. At a constant frequency, lower power generates lower vibration amplitude. Therefore, in order to know the influences of the vibrational power, 6 W, 24 W, 42 W and 60 W were used for dispensing of both materials.

In terms of the powder feeding nozzle geometry, the angle of the orifice between 30° and 60° could generate good flows and the feeding can be accurately controlled with a ratio of 3-8 between the orifice diameter and the maximum powder size. Therefore, the orifice angle was 30° in the experiments. The orifice diameters used in 316L powder dispensing were 0.2 mm and 0.3 mm because powders could not be dispensed with a 0.15 mm diameter nozzle/needle in this experiment. For soda-lime glass powders, feeding nozzle diameters of 0.3 mm (three times of the maximum powder size) and 0.35 mm were compared.

Low flowrate is good for high resolution, while high flowrate can lead to high efficiency.

Therefore, different flowrates have different application purposes. In SLM, two factors are important: flowrate stability and the flowrate. Long-time stable flowrate is necessary for SLM. Therefore, the powder flowrate was measured for 10 minutes. Table 3 shows the specific parameter ranges for the flowrate tests.

TABLE 3
Parameters of the flowrate tests.

| | Powder properties | | Vibrational parameters | | Orifice geometry | |
|---|---|---|---|---|---|---|
| | Powder | | Vibrational | | Orifice | Angle |
| | size | | frequency | Vibrational | diameter | of the |
| Specification | (microns) | Shape | (kHz) | power (W) | (mm) | orifice |
| 316L | 10-45 | Spherical | 28 | 6-60 | 0.2, 0.3 | 30 |
| Stainless | | | | | | |
| Steel | | | | | | |
| Soda-lime | 30 and 90 | Spherical | 28 | 6-60 | 0.3, 0.35 | 30 |
| glass | | | | | | |

### Results and Discussion

Powder Flowrate Characteristics

In order to demonstrate the advantages of the dual PZT (piezoelectric transducer) feeding system, the flowrate of the single PZT (at the nozzle/needle) feeding system was compared. Feeding of soda-lime powders with 42 W PZT power and 0.35 mm nozzle/needle diameter was examined. It can be seen from FIG. 6 that the flowrate was stable constant initially, but reduced after about 450 s. This was caused by the weight change during deposition and partial powder jamming.

TABLE 4
Flowrates of both 316L and soda-lime glass by different orifice diameters and power
using the dual PZT feeding system.

| | 316L | | Soda-lime glass | |
|---|---|---|---|---|
| Power | 0.2 mm | 0.3 mm | 0.3 mm | 0.35 mm |
| 6 W | 1.25 ± 0.1 mg/s | 3.38 ± 0.08 mg/s | 1.1 ± 0.1 mg/s | 3.38 ± 0.12 mg/s |
| 24 W | 2.07 ± 0.08 mg/s | 12.02 ± 0.13 mg/s | 1.27 ± 0.02 mg/s | 4.18 ± 0.15 mg/s |
| 42 W | 3.02 ± 0.07 mg/s | 28.4 ± 0.1 mg/s | 2.13 ± 0.15 mg/s | 5.37 ± 0.08 mg/s |
| 60 W | 4.45 ± 0.05 mg/s | 31.53 ± 0.19 mg/s | 3.12 ± 0.18 mg/s | 5.80 ± 0.15 mg/s |

Flowrates of 316L and soda-lime glass powders with different needle/nozzle diameters and powers for the dual PZT feeding system are shown in Table 4. For the 0.2 mm diameter of the feeding nozzle and 316L powders, flowrates increased gradually with the increasing ultrasonic power. However, for the 0.3 mm diameter needle/nozzle, it sharply increased from about 3.38 mg/s at 6 W to about 12 mg/s when the power was 24 W and the flowrate reached about 31.53 mg/s at the peak power of 60 W. Compared with 316L, soda-lime glass powders showed smaller differences at different powers. Increasing stable flowrates can be obtained by the 0.3 mm nozzle orifice diameter higher ultrasonic vibration powers. For the 0.35 mm diameter nozzle, the flowrates increased gradually with the power increasing from about 3.38 mg/s at 6 W to about 5.80 mg/s at 60 W.

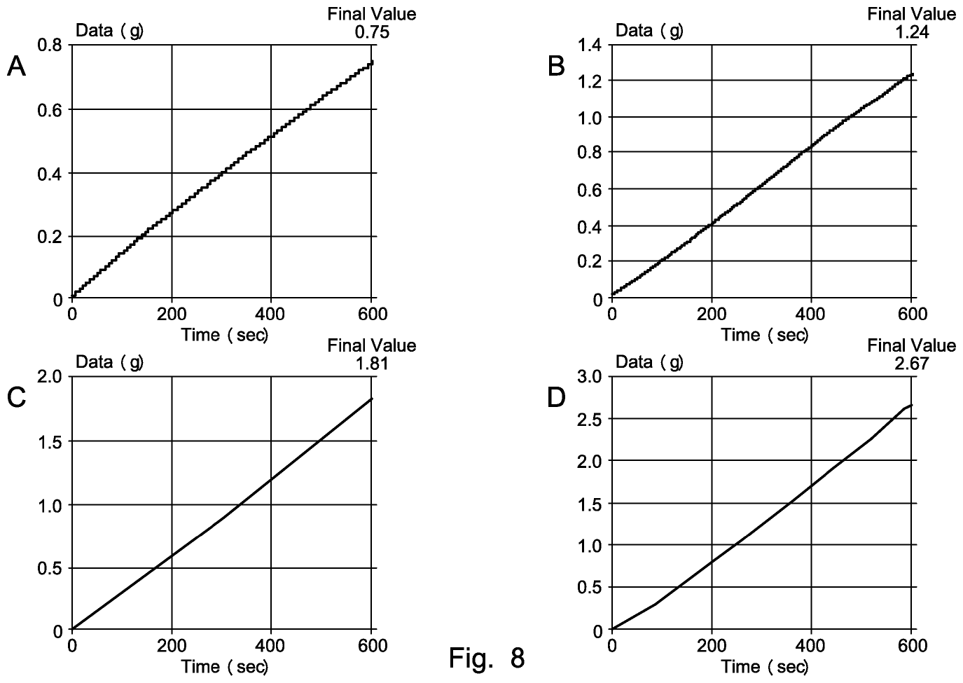

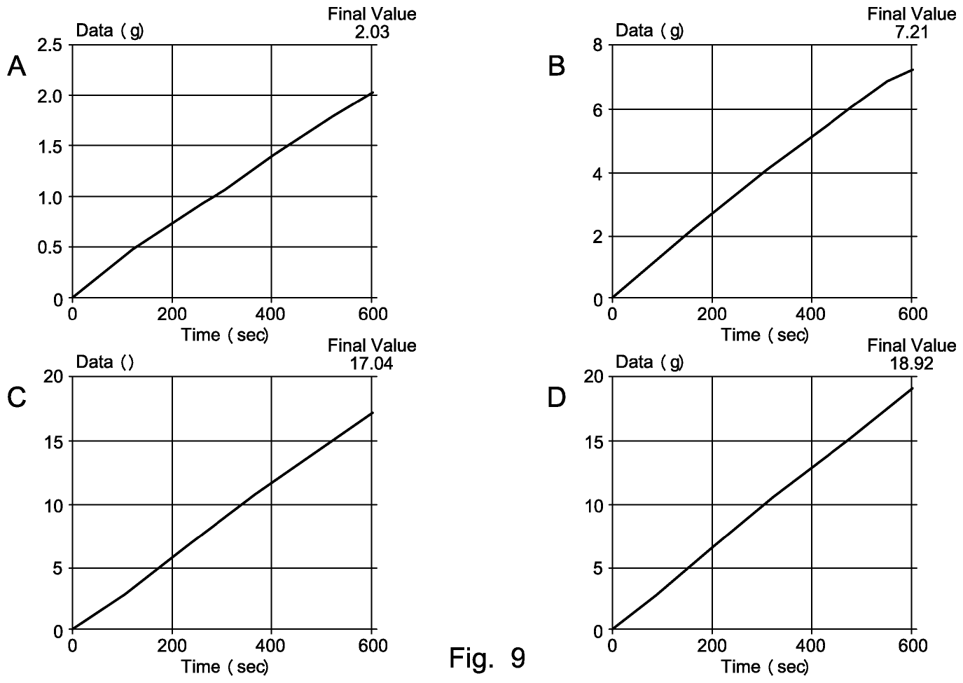

From FIG. 7, 316L powders lines increased slightly without fluctuations and its gradient was constant in each chart. Even though the power was as low as 6 W and the needle/nozzle orifice diameter was 0.2 mm, the flowrate was constant as shown in FIG. 8(a). In FIG. 9, flowrates were also stable during dispensing at each power levels. However, the flowrate started to increase sharply since the power reached 24 W. This is because the ratio between the orifice (0.3 mm) and the powder size (10-45 μm) was about 7, which was relatively large.

Therefore, when the power was higher, the powder flow would increase quickly.

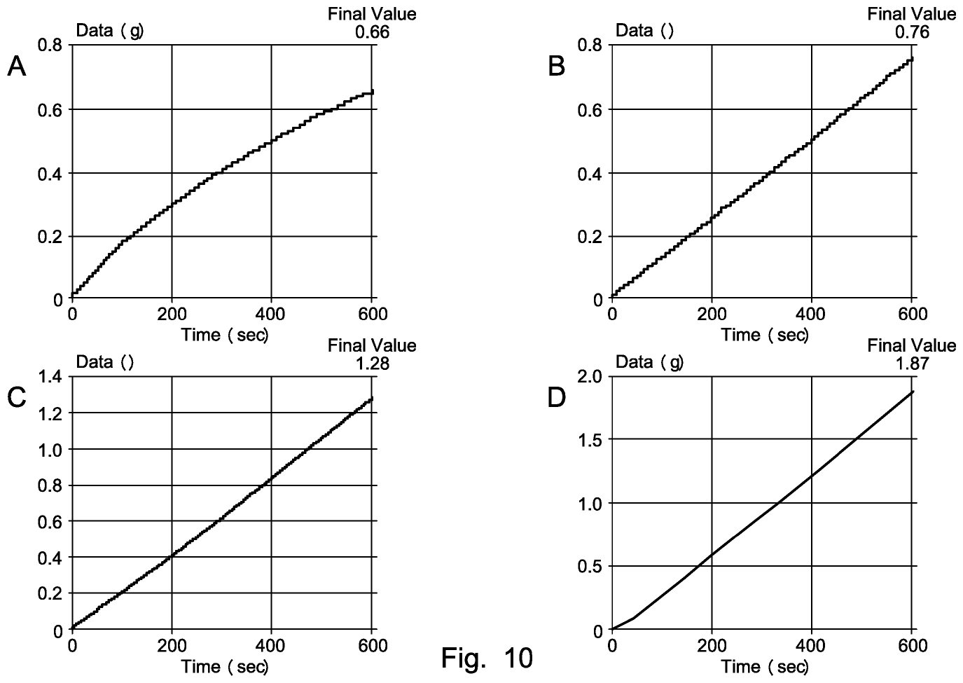

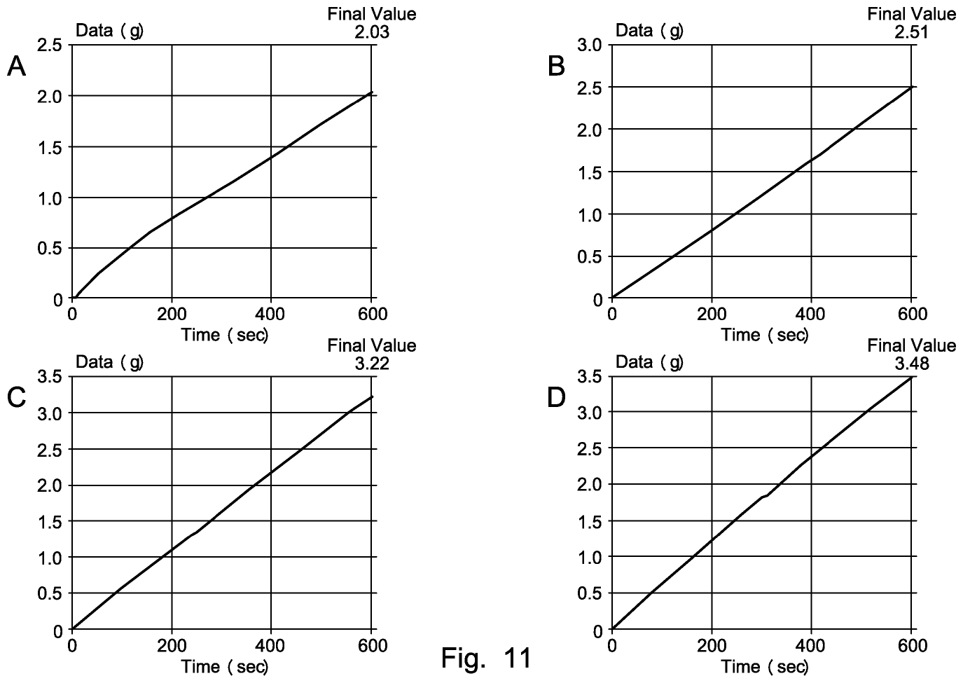

The bimodal soda-lime glass powders in this experiment were a mixture of 1:3 (30 μm : 90 μm) powders. Powders of 90 μm diameter were sand-like, thus the flowability was very good. However, the 30 μm diameter powders were very cohesive and were unable to be delivered directly using the ultrasonic delivery system. For the bimodal mixture when the 0.3 mm and 0.35 mm diameter nozzles were used, the bimodal soda-lime glass flowed very well and the flowrate was constant as shown in FIGS. 10 and 11. Similar to the 316L powders, the soda-lime glass powders also showed very good flowrates for the 0.3 mm diameter and 0.35 mm diameter needle/nozzle orifices for ultrasonic powers from 6 W to 60 W.

From FIG. 8 to FIG. 11, it can be seen that in a certain range of the orifice diameters (0.2 mm-0.35 mm) and power (6 W-60 W), stable flowrates can be achieved by the dual ultrasonic vibration feeding system on both 316 L powders and soda-lime glass powders. This is essential for selective depositing of materials for forming patterns in multiple material SLM.

### Deposition on an Inclined Substrate for Stand-off Distance Effect Investigation

On the base of stable flowrate of both powders, deposition qualities of the ultrasonic vibration feeding system could be investigated. Lower flowrate is more suitable of accurate deposition.

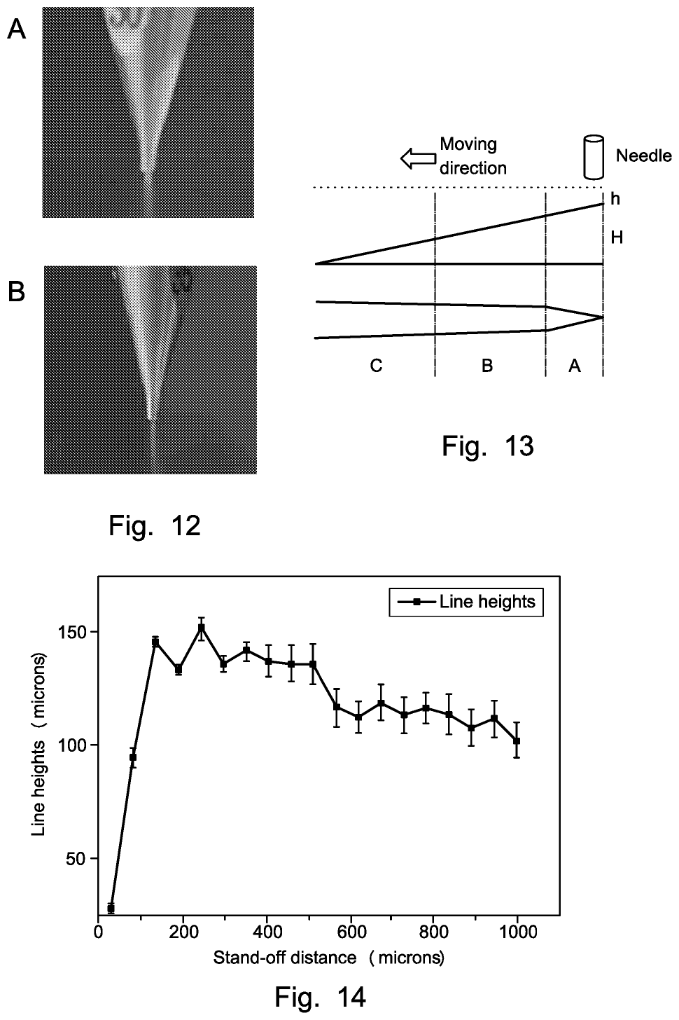

By comparing the flows of soda-lime glass powders at 60 W, and 0.3 mm (FIGS. 12(a)) and 6 W, 0.35 mm (FIG. 12 (b)), it was found that the flow (a) spread around widely when powders came out of the orifice, while flow (b) had a narrow stream. This is because at a higher power and smaller orifice diameter, inter impacts between powders were more severe than those at a lower power and larger orifice diameter. Therefore, lower ultrasonic vibrating power and a larger needle/nozzle orifice diameter were used in the experiments.

The relationship between the deposition track geometry and the powder flow rate is shown in Equation (3):

Powder density×cross section area×s canning speed=flowrate (3)

where the flowrate and the powder density are constant. The scanning speed, stand-off distance (the distance of the tip of the nozzle to the top of the substrate) and the orifice diameter control the cross-section area of the deposited track. Therefore, the stand-off distance and the scanning speed are two main factors affecting the deposition accuracy. It was understood that higher scanning speeds lead to smaller cross-section areas. Therefore, in order to understand the effect of the nozzle/substrate stand-off distance on deposited line cross-section height and width, the scanning speed was kept constant and the stand-off distance increased linearly. Powder lines were deposited onto an inclined plate with a linear increasing height as shown in FIG. 13.

FIG. 13 is the scheme of the inclined single track experiments where H is the highest point of the substrate (1 mm from the base), h is the stand-off distance which was 0.02 mm at the initial point. The horizontal length of the substrate was 64 mm in this experiment. Therefore, the stand-off distance of a position can be calculated by the horizontal displacement and the slope (tanθ=1/64). The inclined glass plate had a flat and smooth surface and it was covered by plastic tape for powder catchment and observation. A Keyence VHX-5000 optical microscope was used for measuring line widths and line cross sections. All parameters for powder dispensing were the same as those in Table 3. Therefore, the powder flowrate was constant. The scanning speed was 3000 mm/min. 316L powders were used in this experiment. The vibrational power was 6 W and the needle/nozzle orifice was 0.3 mm. The corresponding flowrates can be seen in Table 4.

FIG. 14 shows the results of the line heights of 316L in the deposition on the inclined substrate. It sharply went up from 0 to about 150 μm and then reduced gradually with the stand-off distance increasing. When the stand-off distance reached 1000 μm, namely the highest point in this experiment, the line height reduced to about 100 μm, which was about twice of the maximum powder size.

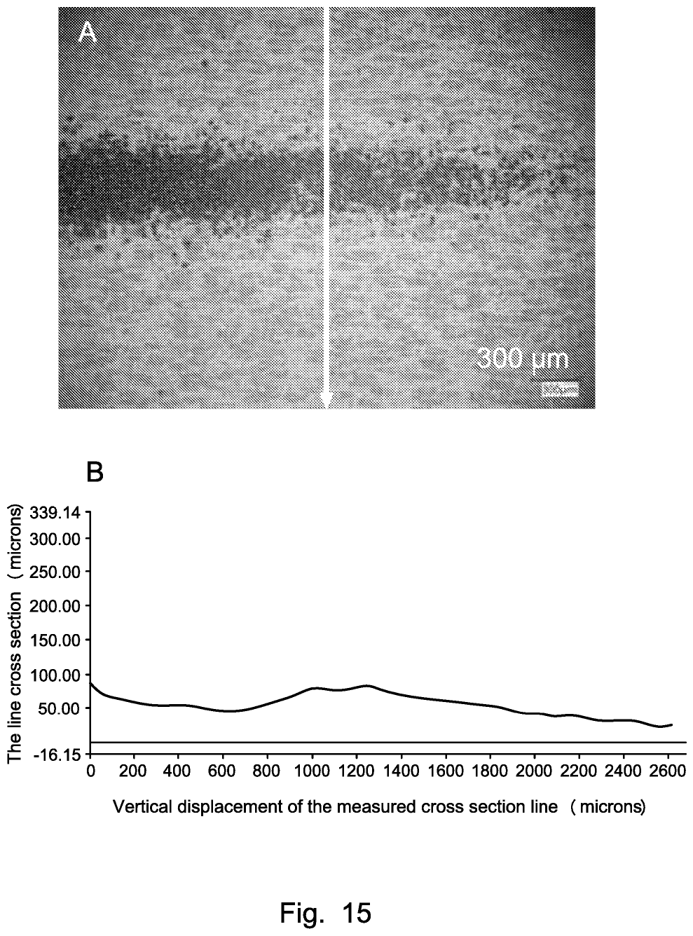

As shown in FIG. 13, the deposited line can be divided into three regions. Region A: the ratio between the stand-off distance (h) and the powder size (d) was less than 1. Region B: this ratio was 1-3. Region C: this ratio was greater than 3. In the initial part of the line, namely Region A (FIG. 15), the line height (thickness of the deposited layer) was less than 27 □m which was equal to its corresponding stand-off distance. The line top was in contact with the powder delivery nozzle. Therefore, it was scraped by the nozzle.

There is a transition from Region A to Region B. During the transition, the line height increased with the increase of the stand-off distance until the stand-off distance reached about 150 μm.

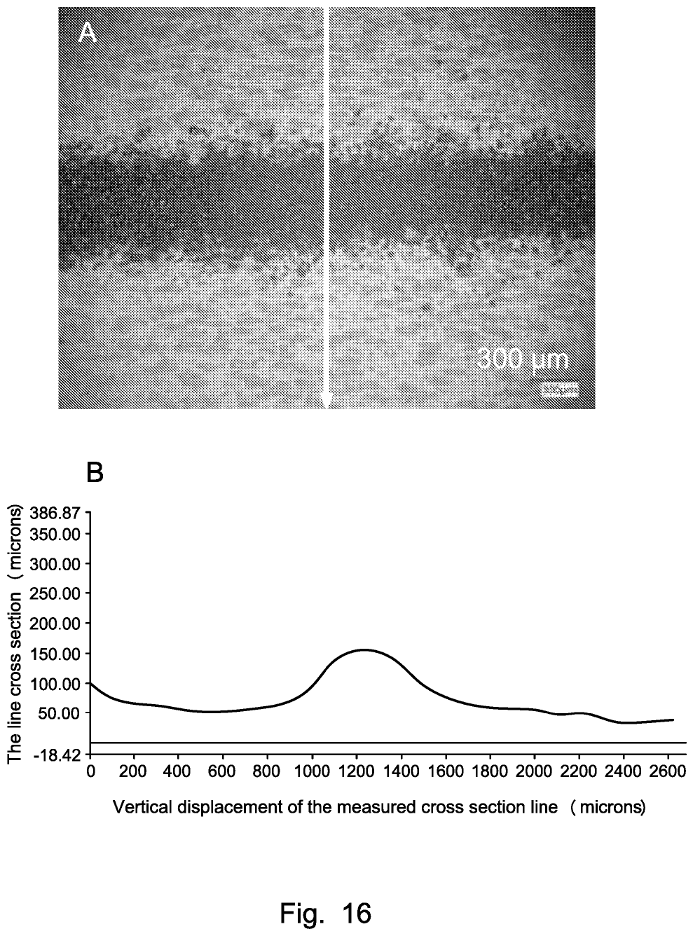

The line width was similar to that of Region A, while the line height was much higher (about 150 μm according to FIG. 16). The top surface of the powder line top was swept by the orifice edge to form the trapezoid cross section and the clear edge of the line can be seen. In Region B, the h/d ratio was between 1 and 3.

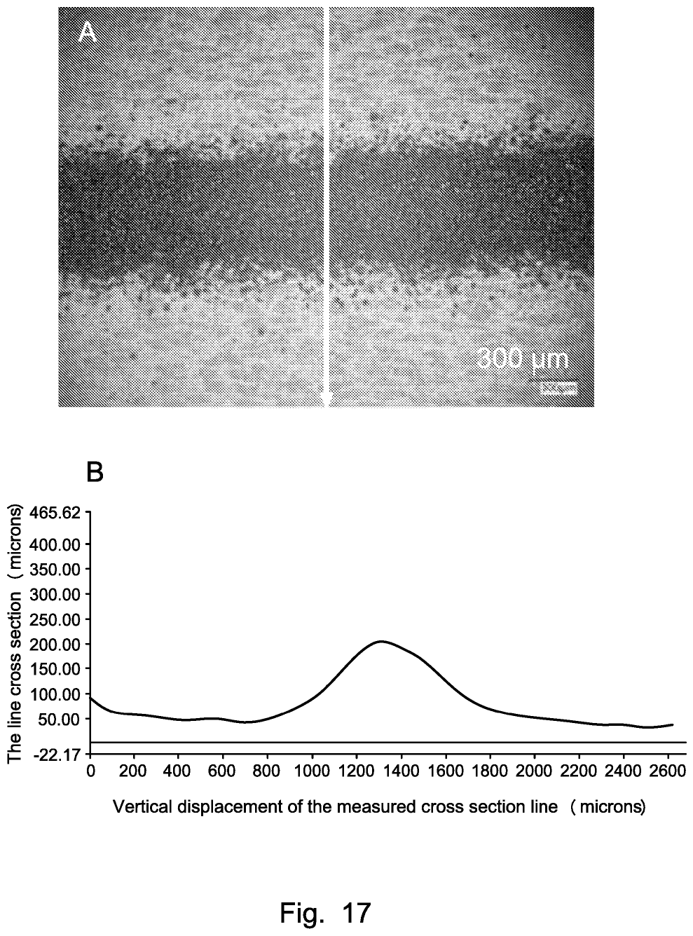

In Region C (FIG. 17), since the powder delivery nozzle was not in contact with the top of the delivered powder lines, when the ratio h/d was more than 3, the line was formed by the powder in free fall by gravity. The cross-section shape was like a mountain and was decided by the powder cohesion. With the stand-off distance increasing further, the line width increased and the line height reduced. Powders may have spread out of the line due to high stand-off distance of the powder delivery nozzle.

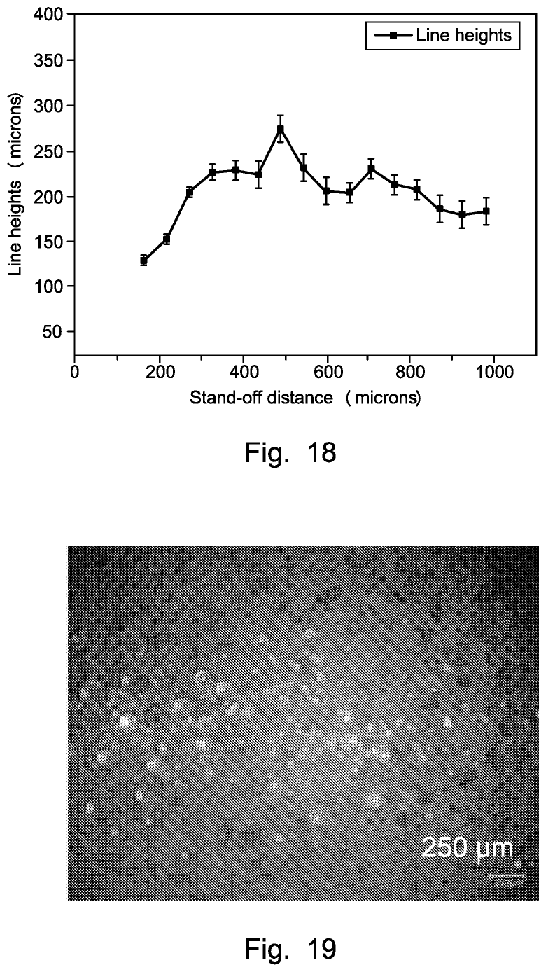

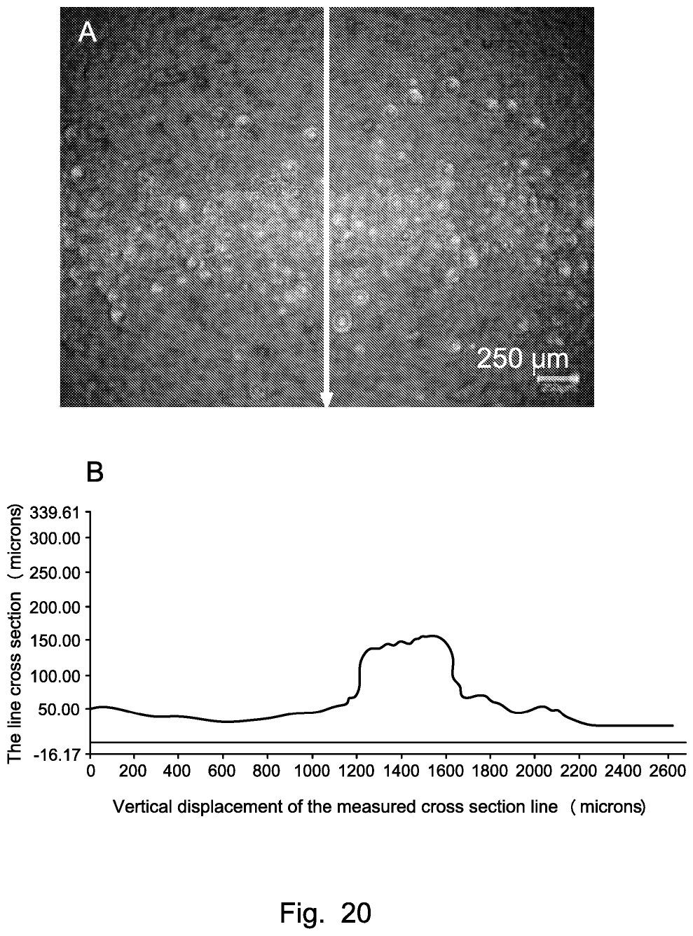

For experiments on soda-lime glass powders, the needle/nozzle orifice diameter was 0.35 mm and the vibrational power was 6 W. FIG. 18 shows the line height during the deposition. From FIG. 18, the powders could not be dispensed onto the plate until the stand-off distance reached 100 μm, which was also shown in FIG. 20. At the initial stage of the powder line deposition, the powders were scattered. A line could be formed when the stand-off distance reached about 163 μm and the line height was about 128 μm as shown in FIG. 19. The line height increased with the increase of the stand-off distance until the stand-off distance reached about 300 μm that is three times of the biggest powder size. After this, the line height reduced gradually, while the line width increased. The lowest line height (FIG. 20) was about 180 μm that is also the thinnest layer thickness, which is about twice the largest powder size.

According to the results shown in FIGS. 14 and 18, a simple first-order formula can be developed for helping understand the approximate line heights of different stand-off distance.

The formula is shown below as:

$$y = x ( x / d \leq 3 ) \\ y = 3 d - \frac{1}{17} ( x - 3 d ) ( 3 < x / d \leq 20 ) \qquad ( 4 )$$

where y is the line height (μm), d is the powder size (μm), and x is the stand-off distance. From Equation (4), it is quick to estimate the layer thickness with the certain stand-off distance in practical processing for the specific materials used. Therefore, the layer thickness can be adjusted by changing the stand-off distance to apply different processing parameters in SLM.

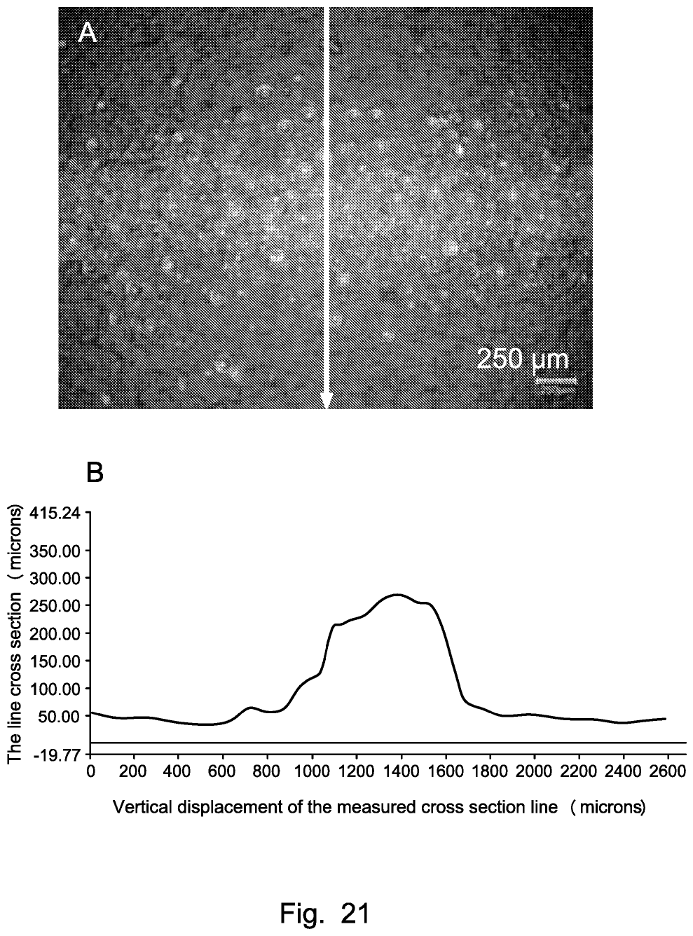

From both results of deposition on the inclined substrate of 316L and soda-lime glass powders, it can be seen that the line cross-section shape was formed by different forces in different regions, as shown in FIG. 21. The line height increased first in Region A and B and it peaked at the three times the maximum powder size. When the stand-off distance exceeded three times of the powder size, the powder nozzle was not in contact with the delivered line top surface and the line height started to reduce slightly. Finally, the line height reduced to twice the maximum powder size.

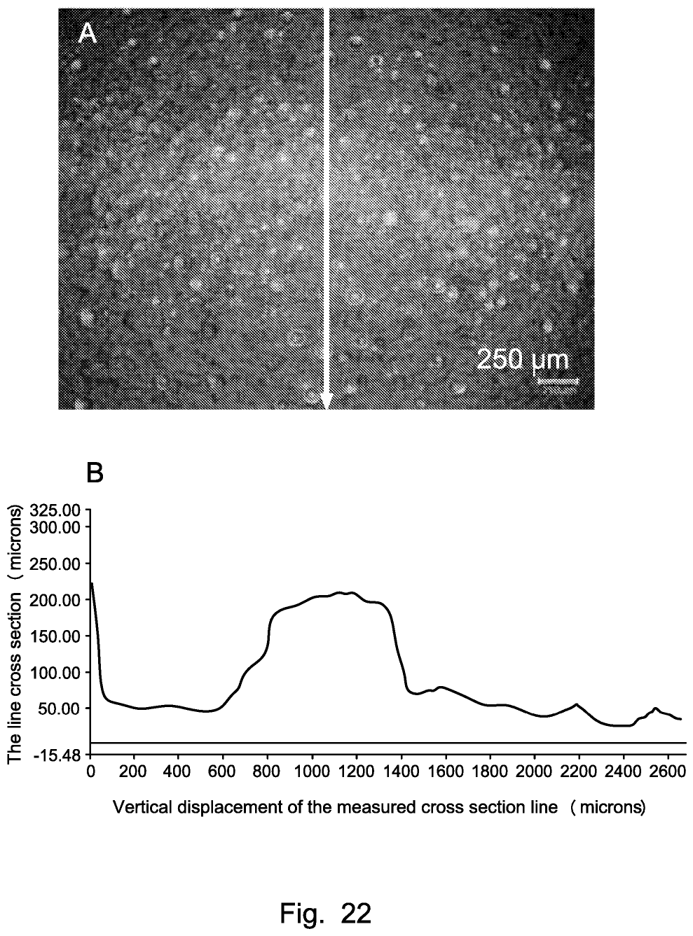

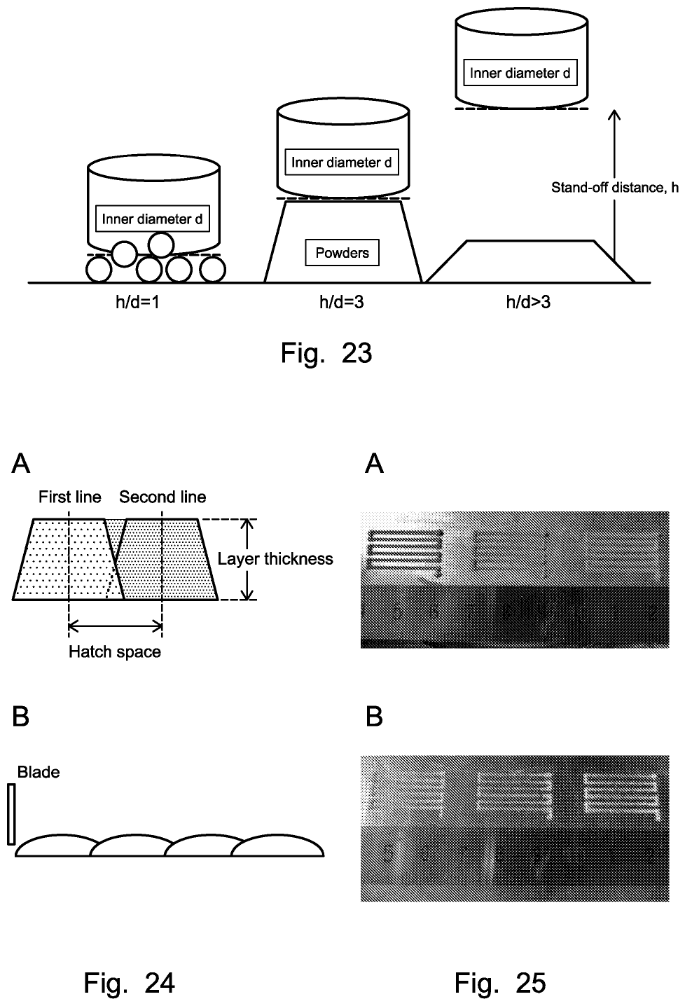

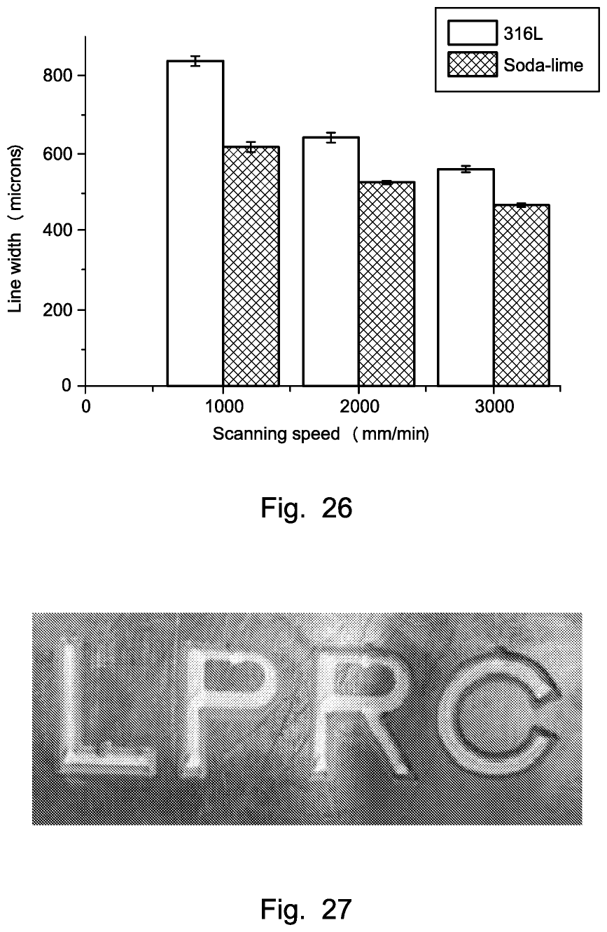

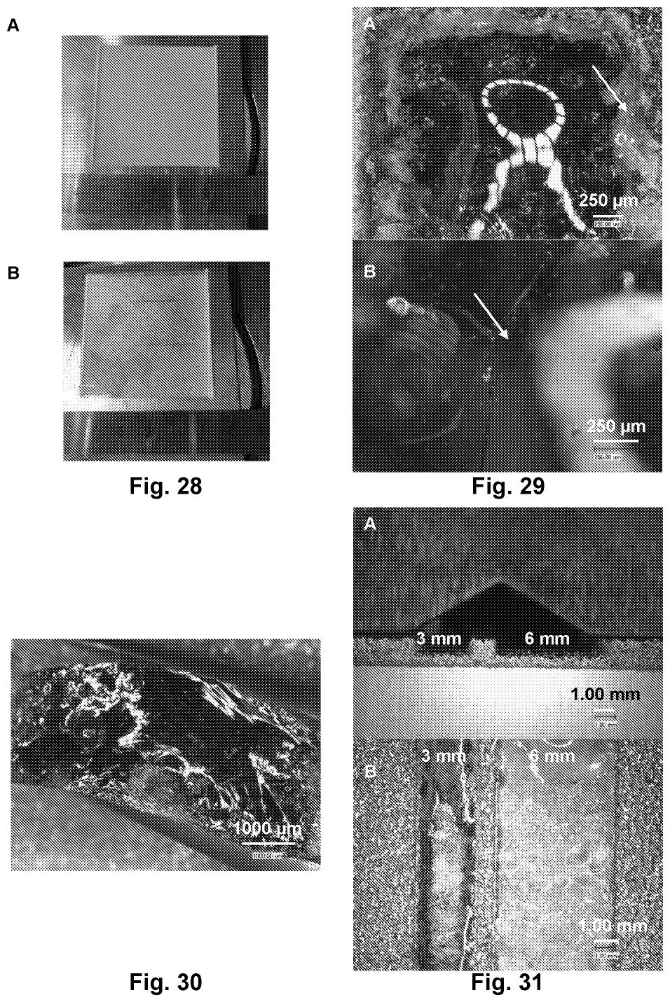

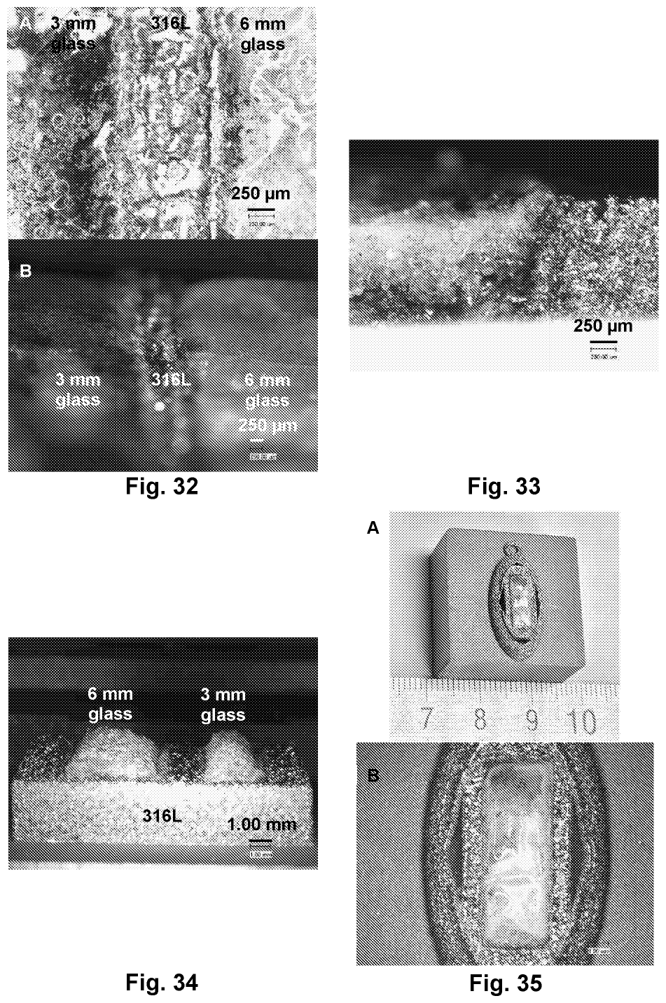

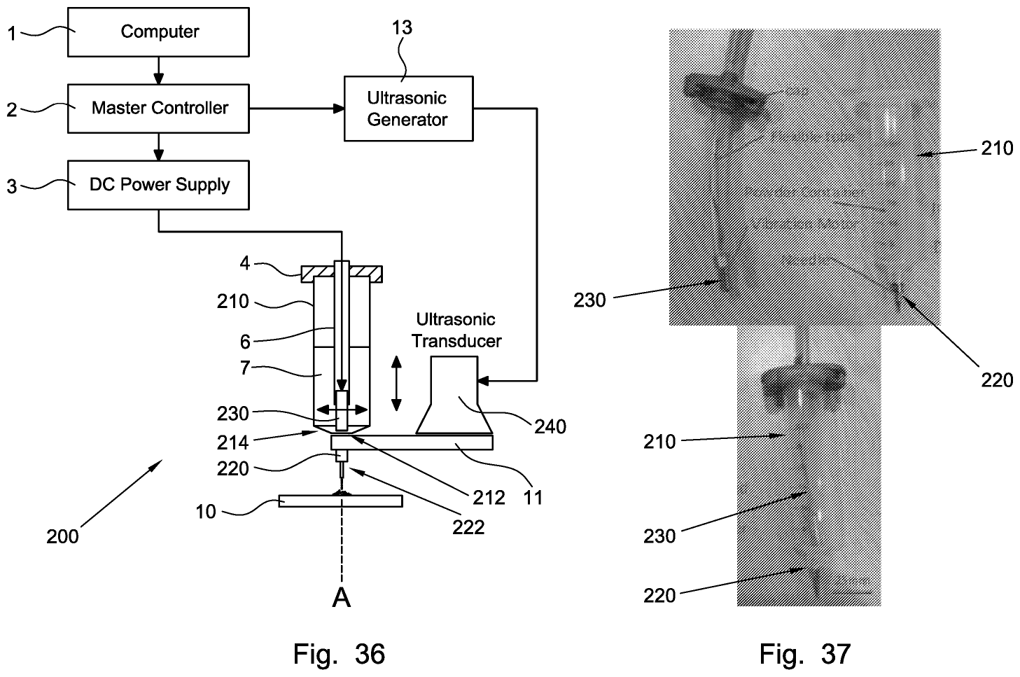

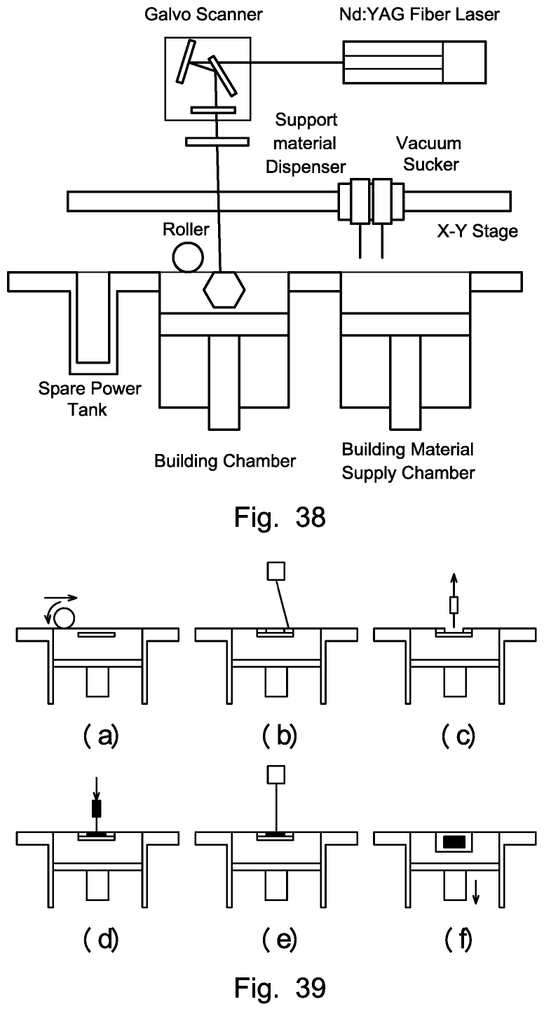

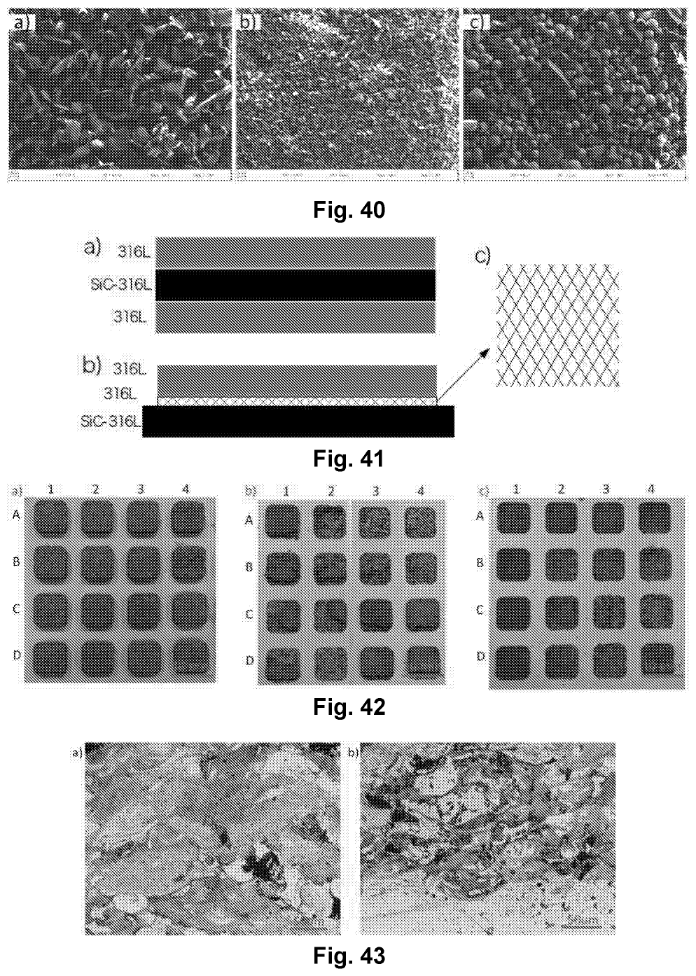

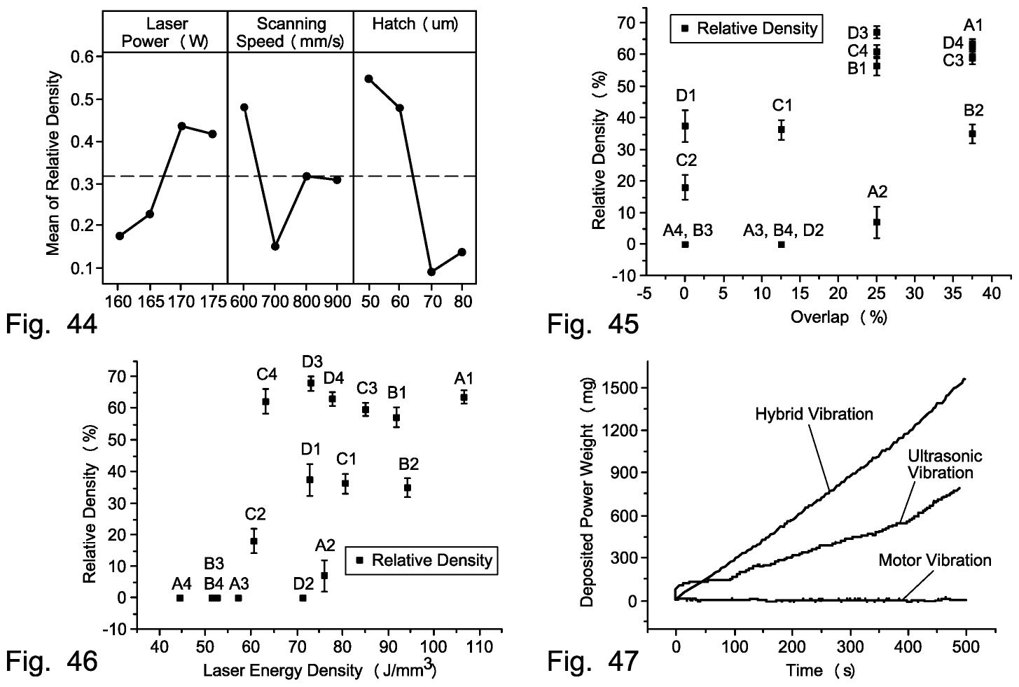

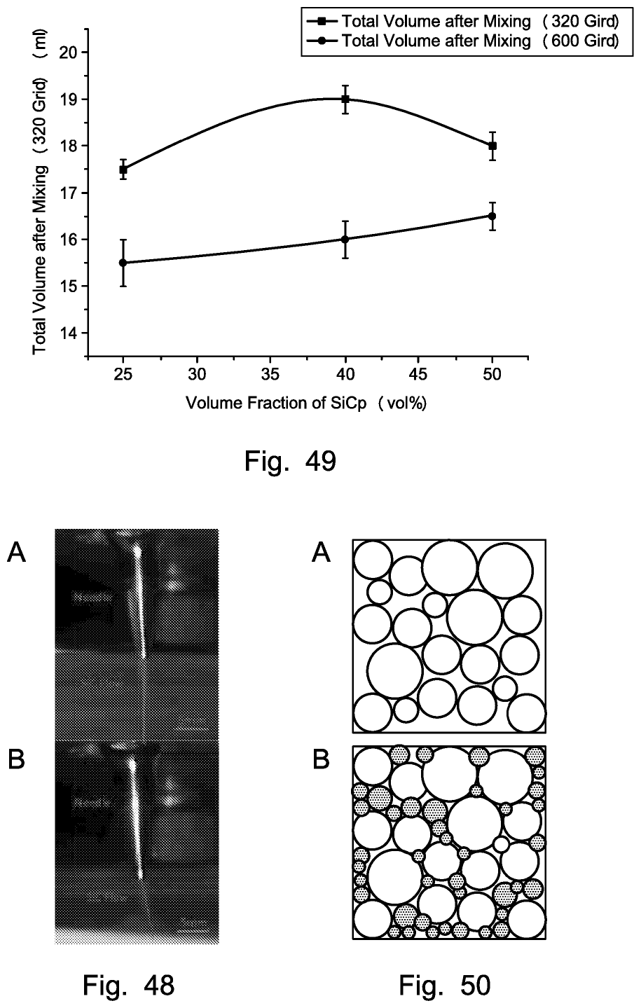

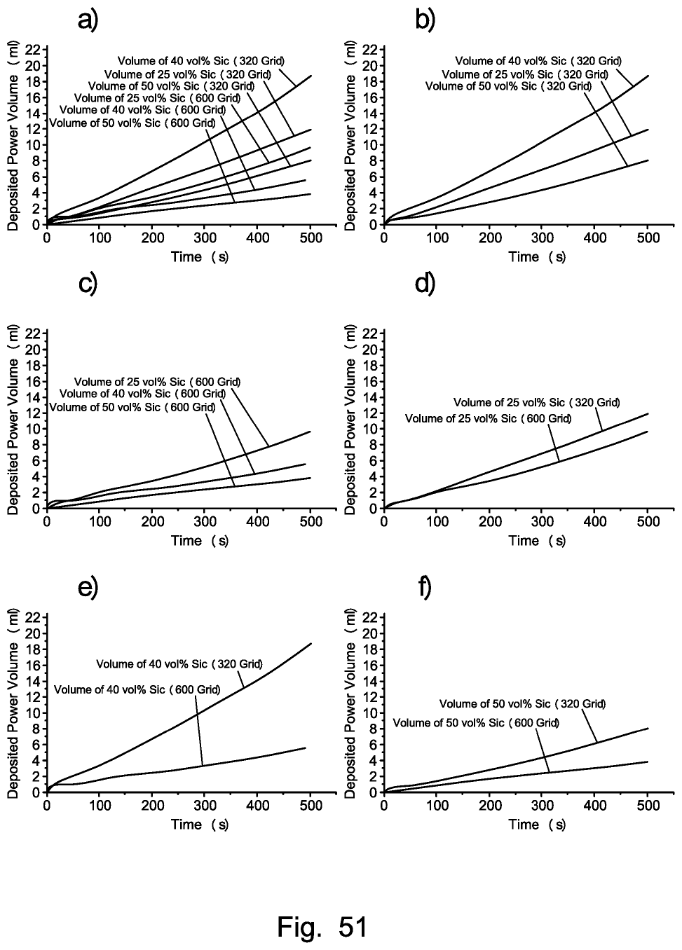

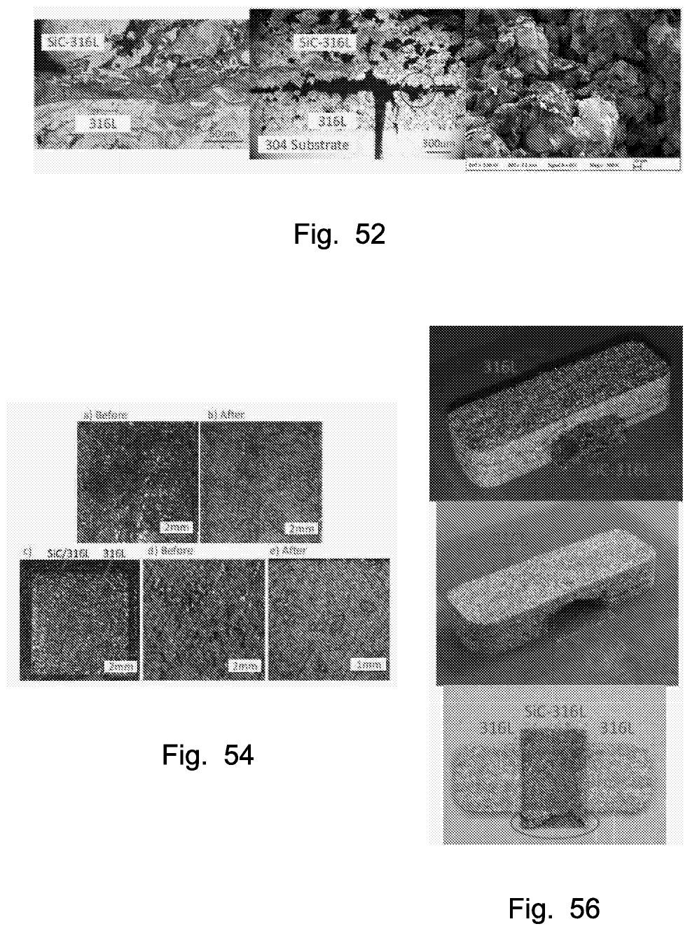

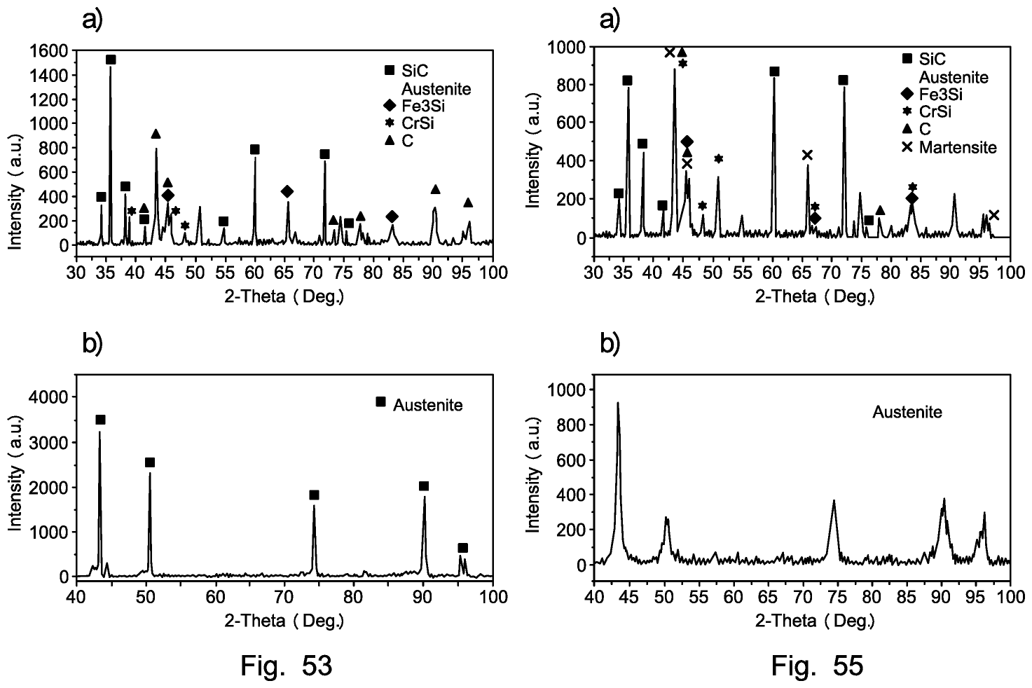

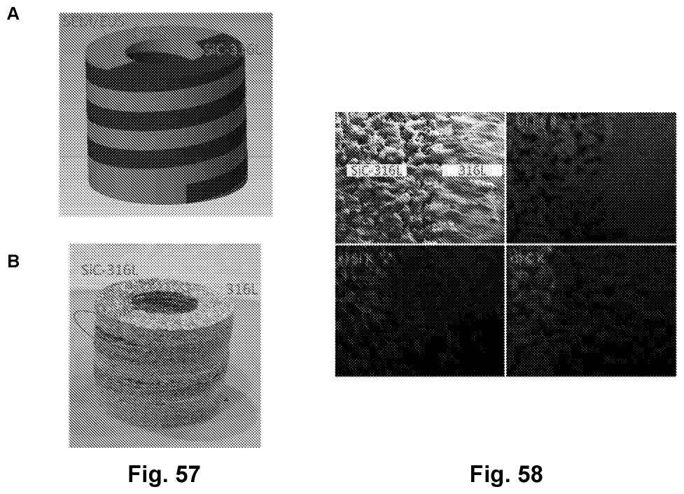

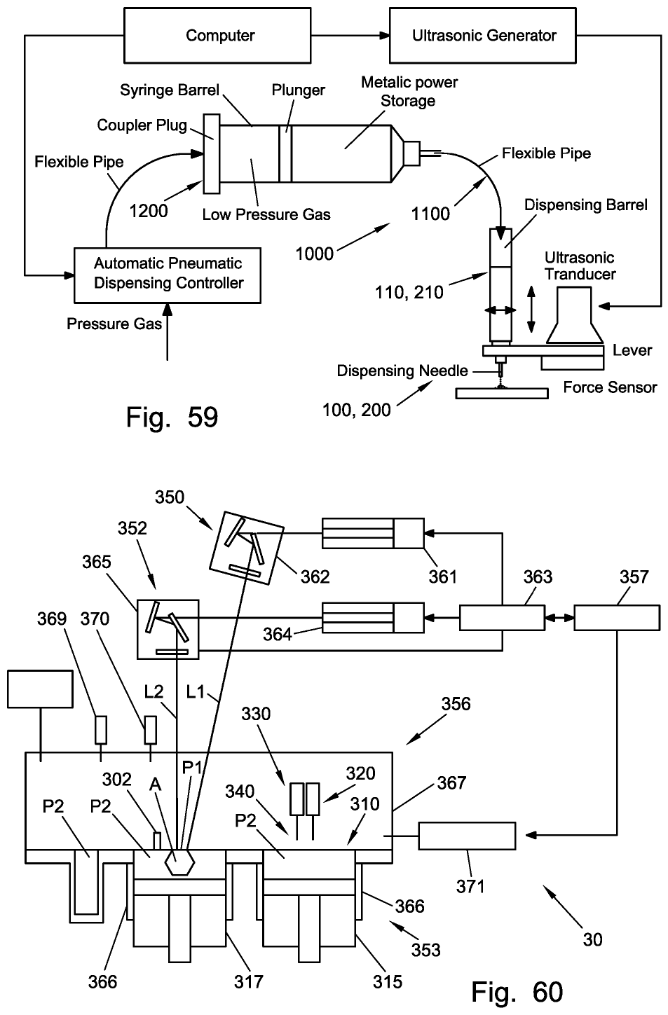

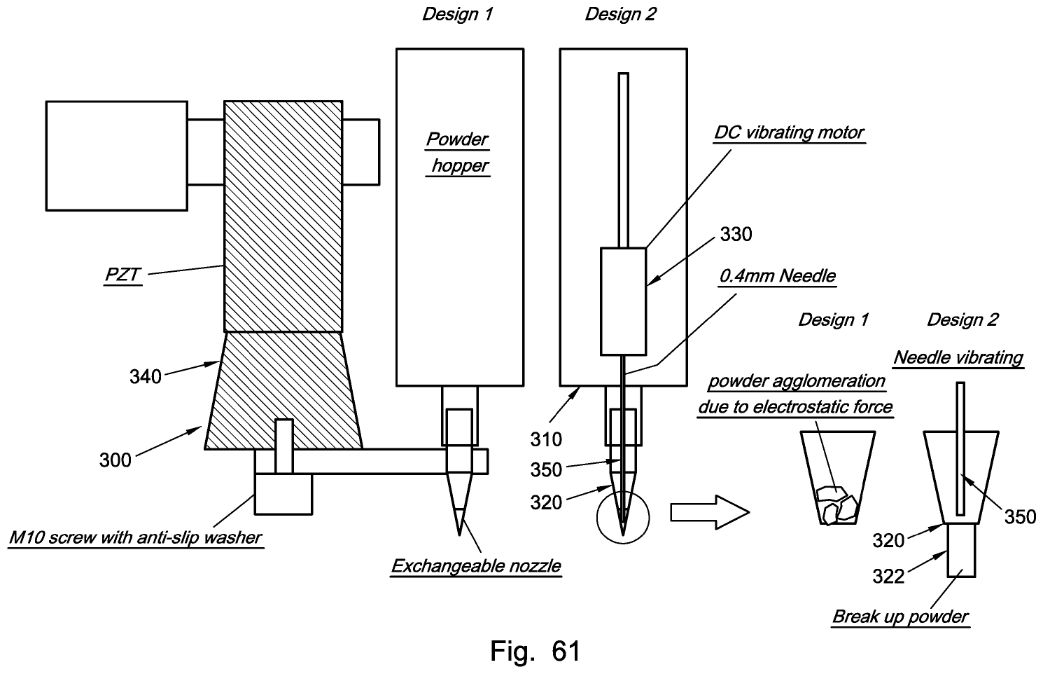

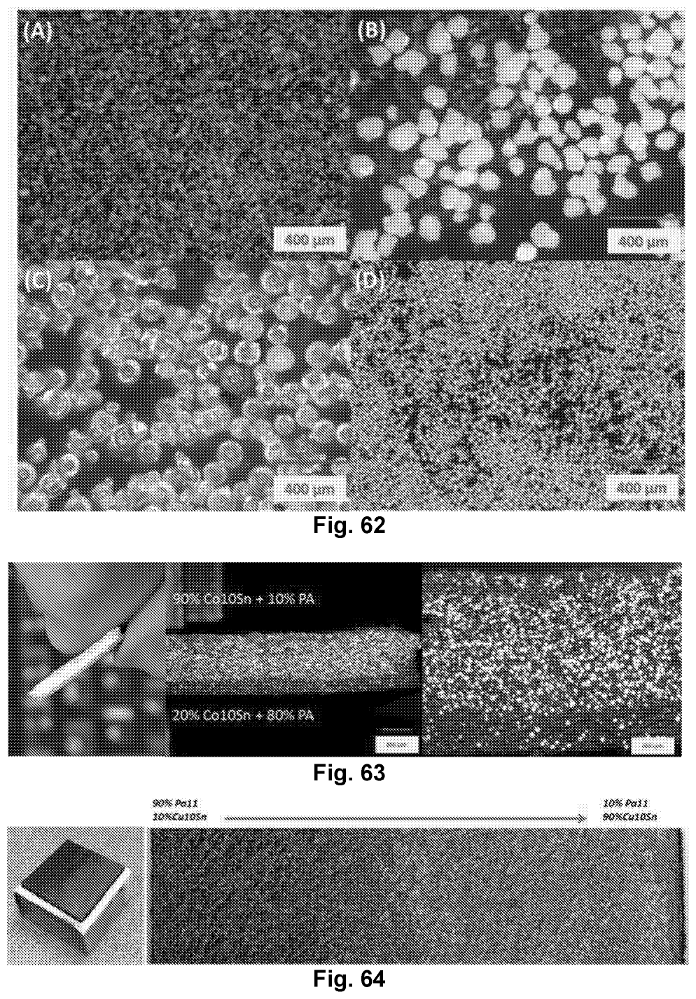

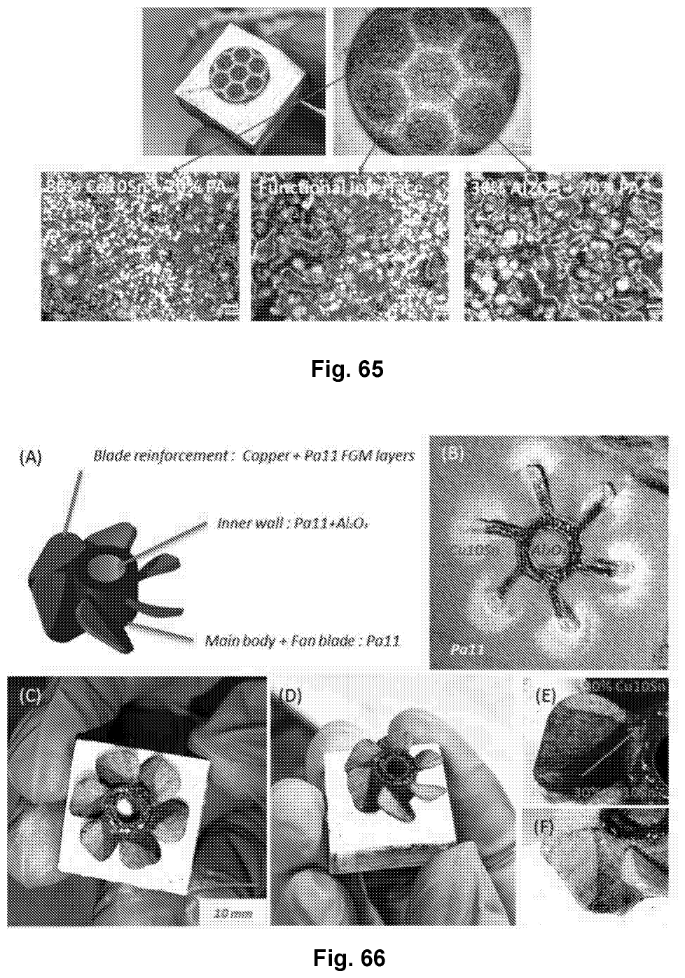

Lines in Region B were thought to be suitable to form layers that for SLM because the trapezoidal cross sections were better for lines to form a layer, as shown in FIG. 22(a). In this region, the ratio h/d was between 1 and 3, which means the layer thickness made in this way would be about three times of the powder size. In SLM, the layer thickness is typically 30-100 μm. Therefore, if the stand-off distance can be a constant at the required layer thickness, the deposited line height can reach a constant layer thickness for laser melting. Therefore, theoretically, line properties in Region B would be suitable for SLM. However, in some processing applications, the part may have distortions or other kinds of transformation due to thermal radiation, so that the part may damage the powder delivery nozzle if the stand-off distance is low. From Region C, the layer thickness can be also as low as Region B even though the line width is big. Therefore, in actual experiments, for protecting the powder delivery nozzle, the stand-off distance was higher than 3 times of the powder size. In order to obtain a flat top powder track surface, a blade of the normal powder bed spreading system was used to scrape the powder surface as shown in FIG. 22(b).

### Effects of Scanning Speed on the Line

Effects of the scanning speed of both materials were also investigated. Parameters are listed in Table 5. The line widths were measured using the VHX-5000 microscope and the results are shown in Table 6. The stand-off distance was 1 mm. This value was selected in practical deposition to avoid damaging the needle. FIG. 24 shows that the higher the speed was, the narrower the line was. For 316 L powders, lines were continuous and uniform at different speeds. On the contrary, soda-lime powders lines were intermittent, especially at 3000 mm/min. This is because hard and light glass powders spread quickly with high kinetic energy when impacting on the substrate at high scanning speeds. While 316L powders have higher mass density, so that they could stay in the line even though the speed was high.

TABLE 5
The parameters used in FIG. 23.

| | Stand-off | Vibrational | | Orifice | Scanning |
|---|---|---|---|---|---|
| | distance | frequency | Vibrational | diameter | speeds |
| Materials | (mm) | (kHz) | power (W) | (mm) | (mm/min) |
| 316L | 1 | 28 | 24 | 0.3 | 1000, 2000, |
| | | | | | 3000 |
| Soda- | 1 | 28 | 24 | 0.35 | 1000, 2000, |
| lime | | | | | 3000 |

TABLE 6
The line widths of different speeds.

| | 1000 mm/min | 2000 mm/min | 3000 mm/min |
|---|---|---|---|
| 316L | 835 ± 15 μm | 642.5 ± 15 μm | 555 ± 9 μm |
| Soda-lime glass | 618 ± 8 μm | 520 ± 5 μm | 465 ± 4 μm |

A pattern of ‘LPRC’ was made by soda-lime glass and 316L powders as shown in FIG. 27.

The deposition parameters are shown in Table 7. The hatch space between lines was 0.5 mm and the scanning speed was 3000 mm/min.

TABLE 7
Optimized dispensing parameters used for making the pattern.

| | Orifice | Vibrational | | Angle of | Scanning | Hatch | Stand-off |
|---|---|---|---|---|---|---|---|
| | diameter | frequency | Vibrational | the | speed | space | distance |
| Materials | (mm) | (kHz) | power (W) | orifice | (mm/min) | (mm) | (mm) |
| 316L | 0.3 | 28 | 24 | 30 | 3000 | 0.5 | 1 |
| Soda- | 0.35 | | | | | | |
| lime | | | | | | | |

The letters were scanned circle by circle. Therefore, powders were stacked at the start of each circle and the corners, which was caused by the acceleration/deceleration during turning directions. Alternative ways can be applied to solve the problem. On one hand, the stack can be reduced by using lower flowrates and lower scanning speeds during deposition. On the other hand, optimizing the scanning strategy can also solve this issue, which is being investigated. A 50 mm square was deposited using 316L and soda-lime glass powders, respectively (FIG. 28) to demonstrate large area uniform deposition using the system.

### Interface Characteristics in Selective Laser Melting of 316L Stainless Steel and Soda-Lime Glass Powders

In SLM a substrate is necessary to anchor the part to avoid thermal distortion. However, it was found that pure glass after being melted could not attach to the flat stainless steel substrate even when the substrate surface was rough (through sand blasting). However, melted glass can penetrate the very rough surface of the 316L parts made by SLM.

The volume energy density deposited in the material in SLM can be calculated using:

$$E = \frac{P}{ν h t} \qquad ( 5 )$$

where P is the laser power, v is the scanning velocity, h is the hatch spacing between scanned tracks and t is the layer thickness. According to Fateri's optimum parameters for glass melting: 60 W power, 67 mm/s scanning speed, 0.05 mm hatch space, and 0.15 mm layer thickness, the volume energy density of soda-lime glass powders was 120 J/mm³. In our research, the laser power was 180 W, scanning speed was 300 mm/s, hatch space was 0.05 mm with an average layer thickness of 0.15 mm in order to increase processing efficiency. The volume energy density was about 114 J/mm3. A twenty-layer 5 mm×5 mm rectangular block of soda-lime glass was produced on a 1 mm-thick 316L deposited metal based layer as shown in FIG. 29. Transparent and smooth surface with some micro-cracks can be seen in FIG. 29 (a) and (b). Its edge was the Heat Affected Zone (HAZ) where the powders were not fully melted and many pores can be seen in FIG. 29(a). FIG. 30 shows the cross section of the block. It can be seen that the glass powders were fully melted in the body of the part. There were no lines of layers from the view of the cross section.

In order to investigate characteristics of the interface between 316L and soda-lime glass, a base of 316L was manufactured using SLM as shown in FIG. 31(a). Two 20 mm-long slots were produced with 6 mm width and 3 mm width, respectively, which were deposited by the ultrasonic vibration feeding system and melted by the laser layer by layer. Ten layers were made and the total thickness was about 0.84 mm. The layer of soda-lime glass powders were deposited by the system and melted by the laser. All laser parameters and deposition parameters are shown in Tables 1 and 7, respectively.

From FIG. 32, it can be seen that the 3 mm-width part was more fully melted than the 6 mm-width one. The transparent part can be seen in the body of the 3 mm-width one and pores can be seen in the 6 mm-width part. This is because the heat generated by the laser stacked during two short scans due to very low thermal conductivity of the glass material. However, the heat dissipation was more during the two long scans. Therefore, the 3 mm-width part was better melted than the wider one. This also means laser processing parameters on glass powders should be optimized according to different feature sizes, especially the scanning width of the part.

As shown in FIG. 32, a good contact interface can be achieved even though the glass powders and metal powders were melted separately, which can also be seen from the cross section of 3 mm-wide part in FIG. 33. This is because as the volume energy density of melting glass (114 J/mm³) is much higher than that of melting 316L powders (60 J/mm³). The 316L surface can be re-melted during processing glass powders. Therefore, molten pool can be formed by both materials and they can be fused together leading to a good bond between the two materials.

A 3D part made by this method has been demonstrated in FIG. 34. A 5 mm-wide and a 3 mm-wide slots were made. The depth of both slots was 2 mm. Glass was formed in both slots. Glass parts easily shrank and distorted during the melting by the laser due to uneven heat distribution. Side walls of the slot and the rough bottom of the metal base were helpful to anchor the glass parts. Therefore, tight interfaces of both materials are significant for forming glass parts. Compared with 5 mm-wide part, the 3 mm-wide one was shaped better due to being more fully melted. The surfaces of both glass pyramids were sintered instead of fully melted. This is because the edge of each layer during processing was HAZ and powders can only be sintered.

A simple 3D pendant was fabricated by this method in order to demonstrate as shown in FIG. 35. The ellipse body of the pendant was made by 316L and a 3.5 mm×10 mm×1.5 mm cuboid at the centre of the pendant was made by soda-lime glass. From the surface of the rectangular glass in FIG. 35(b), it can be seen that the glass was partially transparent and there were some pores in the glass body, which impacted the appearance. Porosity in the body and at the edge (HAZ) was an issue that requires future work to solve. Optimizing processing parameters or multiple scanning may be an effective way to improve the quality of the glass part.

### CONCLUSION

In order to achieve multi-material SLM, a dual ultrasonic vibration feeding system which dispenses both metal powders and glass powders was combined with a new SLM system. For both the 316L and soda-lime glass powders, the feeding system demonstrated long-time stable powder flowrates at different needle/nozzle orifice diameters of 0.2 mm-0.35 mm and different vibrational powers of 6 W-60 W). Lower power and larger needle/nozzle orifice diameter were used in the experiments in order to generate narrower powder stream.

An inclined substrate was used to understand the effect of stand-off distance on deposited powder track geometry at a constant scanning speed. The results of both 316L and glass showed that when the ratio between the stand-off distance and the powder size (h/d) was smaller than 3, the line heights were nearly the same as the stand-off distance. However, when the ratio was more than 3, the line heights (i.e. layer thickness) reduced to twice the maximum powder size and the line width increased. In practical deposition, the stand-off distance was 1 mm to avoid collisions between the needle/nozzle and the part. The higher the scanning speed was, the narrower the line was. The deposited line widths at 3000 mm/min was about 0.55 mm and 0.47 mm for the 316L powders and soda-lime powders, respectively.

After laser melting on the deposited glass powders, transparent and smooth glass blocks can be obtained, while there were still some cracks on the soda-lime glass. In the Heat Affected Zone, powders were sintered instead of fully melted and much porosity can be seen. On the basis of melting results of 3 mm-wide glass and the 6 mm-wide glass, it was noticed that laser processing parameters on glass powders should be optimized according to different feature sizes, especially the scanning width of the part. Good metal-glass interfaces were achieved from both vertical and horizontal directions because both metal and glass were fused together by the molten pool by high energy density.

In the future work, re-melting can be applied on the HAZ to reduce porosity and fully melt the edge of the part. It is much difficult to achieve large size glass parts due to uneven thermal radiation caused by its high thermal conductivity, which can lead to large shrinkage and distortion of the glass parts. Optimizing laser parameters of different size of the features, especially the scanning width, is necessary. Building metal parts on glass base is also needed to be investigated for more complex 3D metal-glass parts.

### Embodiment 2

### Experimental

In this investigation, silicon carbide (SiC) was selected as part of the support material, as it is well known for its low thermal expansion and high resistance to oxidation even at high temperatures. More importantly, its low ductility and irregularity shape of the powder particles as seen in FIG. 1 can contribute to more stress concentrations in the support material leading to cavity erosion and subsequently composite failure. These features are desirable for removing the support structures.

SiC particle size is critical for the support material premixing as it determines the homogeneous level of two materials mixing/ mechanical alloying. Generally speaking, much smaller reinforcing material particle size is helpful to let the reinforcing material infiltrate into its lattice more easily and reduces the crack growths during processing caused by material thermal expansion differences, whereas larger SiC powder particle size may cause more cracks. For easy-to-removal supporting purpose, SLM processing induced cracks are beneficial. Hence, the particle diameter of SiC was chosen as close to that of the 316L stainless steel powder.

In this study SiC-316L material system and pure 316L powder were used as the support material and building material respectively. The 320 grit and 600 gird fine SiC powder (mean diameter is 45 μm and 25 μm respectively, see FIG. 40a and FIG. 40b were provided by Fisher Scientific UK Ltd, and gas atomized 316L powder (LPW-718-AACF) with a particle size of 10-45 μm was from LPW Technology Limited, UK. The 120 mm diameter and 12 mm thickness substrate plates were made of 304 stainless steel. The SiC-316L composite powders for the deposition flow rate experiment was contained in a 50 mL conical centrifuge tube and vibrated for 10 minutes for each direction along X, Y, Z axes on a vortex mixer. The SiC-316L composite powder with required volume fraction for laser sintering was premixed with a V shape dry powder blender for 2 hours to achieve homogeneous mixing. After that, the composite was dried in a vacuum drying oven at 120° C. for 2 hours to remove the remaining moisture in the powders.

### Experiment Setup

This work was carried out on the same system described in reference to FIG. 60. A 1070 nm continuous wave laser beam with an 80 μm beam spot size from a 500 W Ytterbium fibre laser source (IPG Photonics, YLR-500-WC) was applied to process both the support material and the build material on the building platform. The support and the build powdered materials were delivered by a new multiple powder delivery device including a classic roller assisted powder bed for the build material and a dual vibration point-by-point powder delivery mounted on an x-y CNC gantry system combined with a point-by-point micro-vacuum system as shown in FIG. 38. The processing was carried out under the argon shielding gas environment with oxygen density lower than 0.3%.

In the preliminary support material develoμment experiment, the SiC-316 composite was spread by the roller.

Taguchi's method with 3 laser processing factors and 4 levels (see Table 8) was applied to designing the preliminary support material development experiment on laser processing of

SiC-316L composite in order to reduce number of experiments and effectively identify the key processing parameters. The extracted experiment scheme combining 16 representative square specimens (8 mm×8 mm×3 mm) is illustrated in Table 9, which was used for the processing of 3 sets of SiC-316L composites. The volume fraction of the SiC powder was 25%, 40%, 50% respectively. The laser energy density, Q, was calculated by equation (1), where P presents laser power, V is scanning speed, h is hatch distance, and t is layer thickness. In this study, t was kept at 50 μm. Aiming to produce a high porosity solid structure, the energy density was relatively lower than the required laser energy density for selective laser melting of 316L components, which was normally around 100 J/mm3.

$$Q = \frac{P}{V h t}$$

TABLE 8
Factors and levels for laser processing SiC-316L composite

| Factors | Level 1 | Level 2 | Level 3 | Level 4 |
|---|---|---|---|---|
| Laser power, P | 160 | 165 | 170 | 175 |
| (W) | | | | |
| Scan speed, V | 600 | 700 | 800 | 900 |
| (mm/s) | | | | |
| Hatch distance, H | 50 | 60 | 70 | 80 |
| (μm) | | | | |

TABLE 9
Experiment scheme for laser processing SiC-316L composite

| | | | Hatch | Laser Energy |
|---|---|---|---|---|
| Experiment | Power, | Scan speed, | Distance, | Density Q |
| No. | P (W) | V (mm/s) | h (μm) | (J/mm³) |
| A1 | 160 | 600 | 50 | 44.44 |
| A2 | 160 | 700 | 60 | 51.56 |
| A3 | 160 | 800 | 70 | 52.38 |
| A4 | 160 | 900 | 80 | 57.14 |
| B1 | 165 | 600 | 60 | 60.71 |
| B2 | 165 | 700 | 50 | 62.96 |
| B3 | 165 | 800 | 80 | 71.43 |
| B4 | 165 | 900 | 70 | 72.92 |
| C1 | 170 | 600 | 70 | 72.92 |
| C2 | 170 | 700 | 80 | 76.19 |
| C3 | 170 | 800 | 50 | 77.78 |
| C4 | 170 | 900 | 60 | 80.95 |
| D1 | 175 | 600 | 80 | 85.00 |
| D2 | 175 | 700 | 70 | 91.67 |
| D3 | 175 | 800 | 60 | 94.29 |
| D4 | 175 | 900 | 50 | 106.67 |

### Powder Flow Rate and Stability Experiment

Power flow ability is critical for the SLM process, as it has a significant influence on the powder layer thickness uniformity and subsequently affects the laser energy absorption. However, the irregular shape SiC powder can create agglomeration easily. Such phenomenon leads to very poor material flow capability.

### Experiment Setup

FIG. 36 schematically depicts a powder deposition head 200 according to an exemplary embodiment and FIG. 37 schematically depicts the powder deposition head 200 of FIG. 36, in more detail.

Particularly, the powder deposition head 200 is for an additive manufacturing apparatus. The powder deposition head 200 comprises a hopper 210 arranged to receive a powder therein. The powder deposition head 200 comprises a nozzle 220, having a passageway 222 therethrough defining an axis A and in fluid communication with the hopper 210. The powder deposition head 200 comprises a first actuator 230 arranged to, in use, vibrate the powder in the hopper 210 and thereby control, at least in part, movement of the powder in the hopper 210 towards the nozzle 220. The powder deposition head 200 comprises a second actuator 240 coupled to the nozzle 220 and arranged to, in use, vibrate the nozzle 220, at least in part, along the axis A and thereby control, at least in part, movement of the powder from the hopper 210 through the passageway 222.

In this way, the powder deposition head 200 deposits, in use, the powder at a relatively more constant (i.e. uniform) deposition rate.

The powder deposition head comprises the hopper 210 arranged to receive the powder therein. In this example, the hopper 210 comprises an outlet 212 in fluid communication with the passageway 222. In this example, the hopper 210 comprises a first wall portion 214 inclined to the axis A, forming a funnel towards the outlet 212. In this example, an angle of inclination of the wall portion 214 is at least an angle of repose of the powder. In this example, the angle of inclination is 30° . In this example, the hopper 210 is a conical hopper. In this example, the hopper 210 has a capacity of 50 g. That is, the capacity of the hopper 210 is relatively small. In this example, the passageway 222 has a diameter of 0.8 mm.

In this example, the first actuator 230 is within the hopper 210. In this example, the first actuator 230 is arranged to vibrate, at least in part, orthogonal to the axis A. In this example, the first actuator 230 is a vibration motor, preferably an ERM, arranged to vibrate in a frequency range from 20 Hz to 20 kHz, preferably from 100 Hz to 10 kHz, to vibrate, at least in part, orthogonal to the axis A and is within the hopper 210. In this example, the first actuator 230 is arranged to vibrate with an amplitude in a range from 1 μm to 500 μm.

In this example, the second actuator 240 is a piezoelectric transducer arranged to vibrate at a frequency of 28 kHz.

A new hybrid ultrasonic vibration 240 at the powder delivery nozzle 220 and motor vibration 230 inside the powder hopper 210 was developed. It was intended to feed both irregular and spherical shaped powder materials. As shown in FIG. 36, the powder particles (7) in the powder container (i.e. the hopper 210) drop off from the needle (i.e. the nozzle 220, Musashi needle, inner diameter 0.8 mm in this experiment) mounted on a lever (11). The powder flow on and off was controlled by a piezo transducer (i.e. the second actuator 240, frequency 28 KHz, power 60 W, current 0.4 A). The weight of deposited powder was measured in real time with a micro-balance (10, A&D Limited, EK3001), having a data communication function. In order to avoid the powders near the input aperture of the needle 220 in the fully compact condition, a mini vibration motor (i.e. the first actuator 230, DC 5 V, current 30 mA, speed 11000 rμm), the rear of which was inserted into a flexible tube (6), was inserted into the powder, pressing close to the needle (the nozzle 220) inlet. The piezo transducer 240 and the vibration motor 230 were controlled by an ultrasonic generator (13) and a DC power supply (3) respectively according the control signals sent from the computer (1) to the master controller (2).

### Experimental Procedure

a) Pure 320 grit SiC powder flow rate experiment

Firstly, pure 320 SiC powders were used to examine the dual vibration dispenser system performance at the worst condition. As the pure SiC powders have extremely poor flow capability and can become agglomerated easily after ultrasonic vibration.

Three experiments were carried out, under ultrasonic vibration only, motor vibration only, and ultrasonic/ motor hybrid vibration respectively. SiC powders (20 mL, 320 grit) were contained in the dispenser in each experiment. The processing time was 500 seconds each.

b) SiC-316L composite powder flow rate experiment

SiC-316L composite powder deposition flow rate experiment was carried out in advance before printing the components with support structures. There were 6 sets of experiments carried out. Each one lasted 500 s. The 320 grit and 600 grit SiC powders were blended with 316L powder having a volume fraction of 25%, 40% and 50% respectively.

The volume for each material in the composite before mixing and after mixing was measured separately with a 10 mL graduated cylinder, according to the values given in Table 10.

TABLE 10
SiC-316L composite powder volume fractions used in the experiment.

| | Volume before mixing (mL) | | |
|---|---|---|---|
| Content | SiC powder | 316L powder | Total |
| 25 vol. % SiC (320 grit) | 5.0 | 15.0 | 20.0 |
| 40 vol. % SiC (320 grit) | 8.0 | 12.0 | 20.0 |
| 50 vol. % SiC (320 grit) | 10.0 | 10.0 | 20.0 |
| 25 vol. % SiC (600 grit) | 5.0 | 15.0 | 20.0 |
| 40 vol. % SiC (600 grit) | 8.0 | 12.0 | 20.0 |
| 50 vol. % SiC (600 grit) | 10.0 | 10.0 | 20.0 |

After the flown powder weight was acquired, equation (2) was applied to evaluate the volume of deposited powder Vol , where Vol is deposited powder total weight measured by the balance, p₁ and p₂ present the apparent density of SiC and 316L powder respectively. P₁ and P₂ are the volume fraction of above two materials. The apparent densities of 320 grit SiC powder, 600 grit SiC powder and 316L powder in this investigation were 1.27 g/ml, 0.93 g/ml, and 4.42 g/ml respectively. Such data were calculated by measuring each material density for 5 times, then evaluating their mean values.

$$V o l = \frac{W}{( {ρ}_{1} {P}_{1} + {ρ}_{2} {P}_{2} )}$$

Experiment on SLM of 316L Components with SiC-316L Support Structure

After the optimum SiC-316L support material processing parameters were determined, 3D components requiring support structures were designed. A spiral 3D sandwich structure (20 mm x 20 mm, 2 mm thickness for each layer) as described in FIG. 41a was printed in order to investigate the microstructure and the possible intermetallic in the interface of the building material and the support material. Subsequently a sample with a grid transition layer (see FIGS. 41b and 41c, 10 mm×10 mm×0.5 mm, grid line hatch distance 0.5mm, gird line intersection angle 60°) between the 316L part (10 mm×10 mm×2 mm) and the SiC-316L part (12 mm×12 mm×2 mm) was produced. A 3D bridge component and a double helix structure were then printed.

### Experiment Setup

The experiment setup was the same as that mentioned above in FIG. 38. The 316L powder was spread by the roller and the SiC-316L composite powder was deposited by the dual vibration dispenser.

### Component Printing Process

FIG. 39 shows the multiple material SLM process implemented in this investigation. Firstly, the main building powder material, i.e. 316L was spread for one layer of 50 μm thickness over the substrate with a motorized roller and powder levelling blades. Then the laser beam melted the desired areas. A selective powder removal process then took place to remove powders of a single layer thickness in defined areas, using the micro-vacuum system. The SiC-316L support material powders were then dispensed into some of the vacuum removed areas using the ultrasonic powder dispensers and then melted by the laser beam and partially bonded with the already melted area. After that, the whole processed area was cleaned again with the miniature motorized point-by-point vacuum system in order to avoid the material contamination. Finally the building platform moved down a distance equal to the layer thickness. All above 6 steps were repeated until the whole 3D model was fabricated.

Laser processing parameters for the 316L building material were: laser power 170 W, scanning speed 800 mm/s, hatch distance 90 μm. The support material was blended 40 vol. % 320 grit SiC powder and 60 vol. % 316L powder. The laser processing parameters for such composite were: laser power 175 W, scanning speed 800 mm/s, hatch distance 60 μm. The layer thickness was kept at 50 μm.

### Material Characterization

Archimedes method was used to measure the relative density of laser sintered SiC-316L square specimens in water in the preliminary experiment. The ultrasonic powder depositing flow rate was measured by a micro balance (A&D company, limited, EK3001). Metallographic cross-sections of SLM parts were prepared by cutting, mounting, grinding with 400#, 800#, 1000#, and 1200# grit emery papers, and polishing with 1.0 μm diamond polishing paste. Polished samples were then electro etched in 10 vol. % oxalic acid solution. Optical microscopic images of material interfaces were acquired with a KEYENCE VHX-5000 digital microscope. The material interfaces including the 316L layer and the SiC-316L composite layer of the sandwich component were examined with x-ray diffraction analysis (XRD, PANalytical, XRD 5). The interfaces between SLM processed component and the support structure and the cracked region of the support structure were examined using scanning electron microscopy (Zeiss Sigma VP FEG SEM) equipped with energy dispersive spectroscopy (Oxford Instruments X-maxN 150).

### Results and Discussion

Preliminary experiment on laser processing SiC-316L composite

The SLM processed specimens with 3 different volume fractions of SiC are shown in FIG. 42. The specimens with 25 vol. % SiC as shown in FIG. 42a were firmly adhered to the substrate plate and were only able to be cut off by a disk cutting machine. For the 50 vol. % SiC, there was no solid block found on the substrate except for some black marks which should be sintered SiC powders (see FIG. 42c). That was due to insufficient 316L powder content that could not produce a continuous matrix phase serving as a base to embed the added SiC particles.

FIG. 43 presents the SiC particle distribution in the metal matrix composite with 25 vol % and 40 vol. % SiC powder processed by the same laser parameters. The quantity of un-fused and partly melted SiC particles in the specimen increased with the increasing volume fraction of the SiC. In FIG. 43a, most of SiC particles were well embedded from all sides in the fused 316L matrix material, while in FIG. 43b, much more macro/micro structural defects, including cracks and pores, appeared at material bonding interface, caused by the two material thermal expansion differences. Such defects are the initiators of mechanical fracture that are required for the easy-to-removal support structures.

It is clear that the metal matrix material system with either a too low volume fraction or a too high volume faction of SiC is not suitable to be used as the support material.

We observed significant role of laser processing parameters on the quality of the specimens with 40 vol. % SiC additive as shown in FIG. 42b. It was notable that all these specimens were brittle and could be easily knocked off from the substrate. The A3, A4, B3, B4, and D5 samples had been damaged during the processing due to too weak mechanical resistance. Most of the rest ones were incomplete either. All those samples' true volume was measured by

Archimedes method in water. The final relative density results are shown in Table 11, in which the density levels of the A3, A4, B3, B4, and D5 specimen are considered as zero, as those specimens could not be collected and measured.

TABLE 11
Relative Density for laser processing SiC-316L composite

| | | | Laser Energy | |
|---|---|---|---|---|
| Experiment | Hatch Distance, | Overlap | Density Q | Relative |
| No. | h (μm) | (%) | (J/mm³) | Density |
| A1 | 50 | 0.375 | 106.67 | 0.63 |
| A2 | 60 | 0.25 | 76.19 | 0.07 |
| A3 | 70 | 0.125 | 57.14 | 0 |
| A4 | 80 | 0 | 44.44 | 0 |
| B1 | 60 | 0.25 | 91.67 | 0.56 |
| B2 | 50 | 0.375 | 94.29 | 0.35 |
| B3 | 80 | 0 | 51.56 | 0 |
| B4 | 70 | 0.125 | 52.38 | 0 |
| C1 | 70 | 0.125 | 80.95 | 0.36 |
| C2 | 80 | 0 | 60.71 | 0.18 |
| C3 | 50 | 0.375 | 85.00 | 0.59 |
| C4 | 60 | 0.25 | 62.96 | 0.61 |
| D1 | 80 | 0 | 72.92 | 0.37 |
| D2 | 70 | 0.125 | 71.43 | 0 |
| D3 | 60 | 0.25 | 72.92 | 0.67 |
| D4 | 50 | 0.375 | 77.78 | 0.62 |

The effect of the three key laser processing parameters including laser power, scanning speed and hatch distance on the relative density was evaluated by Taguchi analysis method using Minitab software. The Delta values of the above three parameters were 0.46, 0.33, and 0.26 respectively. The main effect plot as indicated in FIG. 44 shows how each factor affects the relative density. The hatch distance had the largest effect on the sample density. The hatch distance should be chosen as small as possible, around 50 μm in the present investigation. Hatch distance is the key factor determining the laser tracking overlap. According to equation (3), where Ov is the overlap percentage, h is hatch distance, and d is the laser beam diameter, which was 80 μm in this study, the overlap decreases as the hatch distance increases.

$$Ov = 1 - \frac{h}{d}$$

The microstructure and 3D features of SLM processed components may be significantly affected by the laser tracking overlapping value. If there was no overlapping or such value was too small, the powder particles between two laser tracks were hard to be fully melted by the heat transfer from the heat affect zone of the fused liquid phase material and formed a continuous solid phase and microstructure finally. Such influence was much more obvious for the SiC-316L composite. As illustrated in FIG. 45, the specimens with a relative density lower than 40% as the overlap was zero or 0.125. If the overlap was at 25%, it was much easier to form higher density specimens.

We also found that there was no solidification phase of SiC produced as the laser energy density was lower than 60 J/mm3, as indicated in FIG. 46. Such a low energy input was unable to melt or singer the SiC particles. In the laser energy density range from 60 J/mm3 to 100 J/mm3, no obvious relationship between the energy density and sintered part relative density was detected. The highest relative density was found for sample D3 as the laser energy density was 72.92 J/mm³.

From the above experimental work, the SiC-316L metal matrix composite with 40 vol. % 320 grit SiC additive was selected as a SLM processing support material. To sinter or partially melt the above material, the suitable laser scanning hatch distance should be small enough to allow the laser tracking overlap to be more than 25%, and the laser power energy density should be higher than 60 J/mm³. The highest relative density we found in this experiment was 67 %.

### Powder Flow Rate Characteristics of the Dual Vibration Powder Delivery System

### Pure 320 Grit SiC Powder Flow Rate Experiment

The experimental powder flow weight against time in the 3 experiments are shown in FIG. 47. Although the ultrasonic vibration alone was able to deposit the pure SiC powder, the powder flow rate was extremely low, only 790 mg SiC powder was deposited in 500 s and such low flow rate and poor flow stability was unstable for SLM shown in black curve in FIG. 47. According to the red curve of pure motor vibration mode in FIG. 47, the vibration motor alone was unable to dispense SiC particles. In the dual vibration mode, the powders were deposited at a constant speed, more stable and 100% faster than that by the pure ultrasonic dispensing, as shown in the blue curve. The role of the vibration motor was to continually loosen the agglomerated SiC particles near the inlet aperture of the dispenser. From FIG. 48 we observed that the particle flow was always along the Z axis direction under the dual vibration (see the red line in FIG. 48a). If the motor vibration stopped, the flow would depart from the Z axis, and both the dispensing angle to the Z axis and orientation were random (see the red line in FIG. 48b). As the needle aperture was often partly blocked by the irregular shape particles leading to the change of flow path direction. To summarise, the new ultrasonic and motor hybrid vibration system achieved the most stable and high powder flow rate.

SiC-316L Composite Powder Flow Rate Experiment

The composite volumes before and after mixing and related remaining volume ratios are presented in Table 12.

TABLE 12
Volumes and remaining volume ratios of the SiC-316L composite

| | Composite volume (mL) | | Remaining |
|---|---|---|---|
| | Before | After | volume |
| Content | mixing | mixing | ratio (%) |
| 25 vol. % SiC (320 grit) | 20.0 | 17.5 | 87.5 |
| 40 vol. % SiC (320 grit) | 20.0 | 19 | 95.0 |
| 50 vol. % SiC (320 grit) | 20.0 | 18 | 90.0 |
| 25 vol. % SiC (600 grit) | 20.0 | 15.5 | 77.5 |
| 40 vol. % SiC (600 grit) | 20.0 | 16 | 80.0 |
| 50 vol. % SiC (600 grit) | 20.0 | 16.5 | 82.5 |

The deposited powder volume over time is illustrated in FIG. 51a. The slope of each curve is the powder flow rate as indicated in Table 13. The nearly liner curves show that all the composite powders were deposited at their own stable flow speed except for some steep ramps occurring at the start due to the loose powder in the dispensers as shown in FIG. 16a. In FIG. 51b, for the 320 grit SiC, the highest flow rate occurred at 40 vol. % of SiC at which condition its packing density was the lowest comparing to that at 25 vol. % and 50 vol. %. FIG. 51c shows that the powder flow rate decreases with the increasing of SiC additive for the 600 grit SiC. At the same volume fraction level of SiC, the composite flow rate with the 320 grit SiC was always higher than that with the 600 grit SiC (see FIG. 51d to f), as the fine particles of 600 grit SiC increased the powder packing density dramatically and more unregularly sharp particle edges slowed the powder flow rate down. The biggest difference occurred at 40 vol. %. A good powder flow capability is the basic requirement to deposit a homogenous powder layer with constant layer thickness, and leads to a fast building rate. Hence, 40 vol. % SiC additive should be the optimum reinforcement as support material system with the 316L stainless steel as the matrix material.

To conclude, due to much lower packing density caused by 320 grit SiC than that by 600 grit one, 320 grit SiC should be able to create more micro structure defect features in the SiC-316L metal matrix composite, required for the easy-to-removal support structure application. What is more, the highest remaining volume ratio of 320 grit SiC was observed at 40 vol. %. At such a fraction, the highest SiC-316L composite flow rate of 37.53 pL/s was achieved.

TABLE 13
SiC-316L composite depositing flow rate.

| | Flow Rate |
|---|---|
| Content | (μL/s) |
| 25 vol. % SiC (320 grit) | 24.04 |
| 40 vol. % SiC (320 grit) | 37.53 |
| 50 vol. % SiC (320 grit) | 16.18 |
| 25 vol. % SiC (600 grit) | 19.48 |
| 40 vol. % SiC (600 grit) | 11.23 |
| 50 vol. % SiC (600 grit) | 7.95 |

Printing 316L components with SiC-316L support structure in SLM

FIG. 52 shows the micro-structure at the material interface between the middle layer made of SiC-316L composite and bottom layer made of 316L on the sandwich structure in FIG. 41a. A clear interface is shown in the red line region as shown in FIG. 52a, that the micro structure is totally different from that of the building material at the bottom and the support material on the top. After specimen grinding and polishing, such a transition zone was easily erased with the embedded SiC particles and formed large continuous cavities along the transition zone direction and many pores were also formed in the support material region, as indicated in FIG. 52b. The vertical gap penetrating through the 316L and 304 substrate was scratched by the SiC particles during grinding. The internal view of the cavity is shown in

FIG. 52c. It was found that larger 316L powder particles were fully fused and formed molten beads with SiC particles embedded inside. On the other hand, some of the 316L powder particles with diameters around 20 μm were still in incomplete fusion condition. They should be in SiC powder gaps or covered by that and shielded from heat and laser irradiation during the laser processing. Such phenomenon would further reduce the mechanical strength of the metal composite support structure.

The top layer of the sandwich structure shown in FIG. 41a, made of 316L powder, was removed from the support structure, i.e. middle layer of the sandwich, and was then carefully ground from 2 mm thickness to 1mm thickness on its top surface. Both surfaces of this sample were examined by XRD. The XRD profile in FIG. 53a indicates that there were the presence of SiC, austenite, Fe₃Si, CrSi, and carbon at the 316L/SiC-316L interface. It meant decomposition reaction of SiC took place. The thermo-dynamical stability of SiC particles would be affected if they were surrounded with transition metallic material, including Fe, Ni or Ti under the temperature no less than 1073K. Fe silicide i.e. FeSi or Fe₃Si would form after the concentration level of Si diffused to iron liquid overcame a threshold value. Such mechanism was in common with the reaction of SiC/Cr. Carbon would precipitate in the reaction region in the form of carbon. That explained the black color of the squares observed in FIG. 42. Fe silicide in the form of Fe3Si was extremely brittle. Both such feature and the high porosity contributed to the low mechanical resistance of the support structure in this investigation. No contamination was found on the top surface of the 316L part as shown in FIG. 43b. It indicated that the Si and C diffusing to iron liquid was limited in the interface of building material and support material.

FIG. 54a and FIG. 54b present the residual sintered support material, covered the whole bottom of the 316L part, before and after sand blasting. It was clear such contamination was hard to be cleaned. Fe silicide and carbon contained in that was an issue as it had a negative influence on the interface microstructure, composition and defects that may lead to potential fractures and reduce the component fatigue life. Hence a grid transition layer with a material the same as the building material, was introduced to isolate the support material from the build material. FIG. 59b shows the SLM printed sample with transition layer described in FIG. 41b and FIG. 41c. The 316L part on this sample can be easily removed from the support structure. Because the support structure's poor surface roughness, porous structure with embedded SiC and intermetallic reduced the joint strength between the grid layer and the support structure. FIG. 54d shows the 316L grid lines covered by the loose 316L powders and some residual support material before sand blasting. After sand blasting, some grid lines with some fused metal beads were still visible as shown in FIG. 54e.

FIG. 55a demonstrates that sand blasting method was not viable to remove the contamination adhered on material interface, as the harmful intermetallics, including Fe₃Si and C-Fe-Si, and carbon were still observed by XRD on the bottom surface of the 316L steel after sand blasting. On the other hand, no contaminants' XRD signals were detected on the grid on the 316L bottom side after sand blasting as shown in FIG. 20b. This means that the grid structure is an effective barrier to prevent contamination to the build material by the support material.

To demonstrate the practicality of the system for 3D printing, a bridge structure and double helix structure were printed using the modified SLM (see FIG. 56 and FIG. 57). The bridge structure as shown in FIG. 56a was made of pure 316L and the support material was made of the 316L-SiC composite (60%:40%). The sintered support material in the bridge aperture could be easily removed by hand (FIG. 56b). In FIG. 56c, on a laser fused bridge cross section, a very clear interface was seen. A part of the sintered SiC-316L composite rectangle near the bottom edge was cleaned by hand.

In the double helix structure (see FIG. 57a), the 316L part and the SiC-316L part were intertwined around each other, and played the role as support structure for each other as well.

In FIG. 57b, we observed obvious continuous cracks at the material interface.

The interface between the building material and the support material of the double helix at the horizontal plane as pointed by the red arrow in FIG. 57a was examined by SEM and EDS. A single layer of 316L building material covered the right part of the SiC-316L composite support structure as shown in FIG. 58a. The surface roughness of the support structure was poor due to the high porosity and large fused 316L beads with embedded SiC particle. Hence the new added thin layer of building material showed a wavy profile as indicated in FIG. 58a, and some SiC particles embedded in the support material layer penetrated the single building material layer, as pointed by the red arrows. Fe concentration can be seen in FIG. 58b. The black colour on the left side corresponded to the pores and cavities in FIG. 58a. Si and C maps (FIGS. 58c and 58d) indicate the SiC particles were distributed on the left side, i.e. in the support structure region. Some noises on the right side of these two maps were due to SiC particles penetrating the building material layer from the support material layers at the bottom.

### CONCLUSION

This work has demonstrated an easy-to-remove support material and related processing procedure to fabricate the support structures used in an SLM process by combining SiC-316L composite, selective point-to-point powder deposition and removal, and a new multiple material SLM method. Unlike previous SLM processes, the new approach reported in this paper, used a different material as the support material from that of the building material. A new dual vibration powder dispenser for feeding low flow capability powder, integrated into a specific experimental SLM equiμment was developed and employed to produce SiC-316L composite specimens and 3D 316L demonstration components with SiC-316L composite as support structure successfully. The experiment results showed that the SiC-316L composite with 40 vol. % 320 grit SiC was feasible to be applied as a support material, as it can produce more mechanical defects required for the easy-to-remove support purpose. The result indicated a transition zone between the building material and support material that was easily to be broken under a low external force due to the existence of cracks and pores in the support structure. Fe silicide and Cr silicide were found at the 316L/SiC-316L interface. These phases are helpful to decrease the support structure mechanical strength. The XRD result indicated that contaminations induced by support material decomposition were hard to be removed from the 316L part interface with sand blasting. To avoid this, a transition layer in the form of a fine grid structure consisting of the same material as the build material was introduced. The XRD result proved that it was an effective barrier to avoid build material contamination. The optimum grid structure including shape, hatch spacing, thickness should be further investigated.

### Embodiment 3

FIG. 59 schematically depicts a powder reservoir 1000 for a powder deposition head according to an exemplary embodiment, for example the powder deposition head 100 or the powder deposition head 200, as described above.

In this example, the powder deposition head comprises the powder reservoir 1000 in fluid communication with the hopper 110, 210 and vibrationally isolated therefrom, wherein the powder reservoir 1000 is arranged to replenish the powder in the hopper 110, 210. In this example, the powder reservoir 1000 comprises a flexible conduit 1100, for example a polymeric and/or elastomeric tube, having an end arranged proximal to and spaced apart from a surface of the powder in the hopper 110, 210, thereby vibrationally isolating the powder reservoir 1000 from the hopper 110, 210.

In this example, the powder reservoir 1000 comprises a syringe 1200 arranged to replenish the powder in the hopper 110, 210. In this example, the syringe 1200 is pneumatically actuated. In this example, a rate of actuation of the syringe 1200 is controlled to replenish the powder in the hopper 110, 210 at the same rate as the rate of deposition of the powder by the powder deposition head 100, 200.

Particularly, FIG. 59 illustrates the selectively dry powder dispenser used in this work. In the hybrid powder-bed and ultrasonic nozzle powder delivery system for 3D printing of multiple materials, the use of small ultrasonic delivery hopper and nozzle would enable high resolution and stability of material feeding. However, it can only last for a short period of time, thus not suitable for printing large parts. A cascaded powder delivery system as shown in FIG. 59 enables both accurate and stable powder delivery as well as powder material supply to allow the printing of large components. The secondary powder supply system is a pressure gas driven powder storage unit and is integrated with the ultrasonic dispenser. The automatic pneumatic dispensing controller allows continuous or non-continuous timed supply powders to the dispending barrel. The powders can be metallic, ceramic or polymer type or their mixture depending on the application needs.

### Additive Manufacturing Apparatus

FIG. 60 schematically depicts an additive manufacturing apparatus 30, that may include, for example, the powder deposition heads described with reference to embodiments 1, 2 and/or 3. Particularly, the apparatus 30 comprises a layer providing means 310 for providing a first support layer from a second material P2 comprising particles having a second composition, wherein the first composition and the second composition are different, a concavity defining means 320 for defining a first concavity in an exposed surface of the first support layer, a depositing means 330 for depositing a part of the first material in the first concavity defined in the first support layer, a levelling means 340 for selectively levelling the deposited first material in the first concavity, and a first fusing means 350 for fusing some of the particles of the levelled first material in the first concavity by at least partially melting said particles, thereby forming a first part of the layer of the article. The layer providing means 310 comprises a powder supply chamber 315, a build chamber 317 and a blade 302, as described above. The powder supply chamber 315 and the build chamber 317 comprise retractable beds, as described above. The layer providing means 310 further comprises a spare powder chamber 318. The concavity defining means 320 is mounted on a X-Y stage, having a Z axis stage, providing movement in three orthogonal directions. The depositing means 330 is mounted on a X-Y stage, having a Z axis stage, providing movement in three orthogonal directions. The levelling means 340 is coupled to the depositing means 330, mounted on the X-Y stage, having the Z axis stage, providing movement in three orthogonal directions. The first fusing means 350 comprises a first laser source 361, a first x-y or x-y-z galvo scanner 362 and a laser controller 363. The first laser source 361 may provide a first laser beam L1 having spot size between 10 μm and 200 μm. Suitable laser sources are known in the art. The apparatus 30 further comprises a controller 357 arranged to control the apparatus 30. The apparatus 30 comprises a removing means 351 for removing at least some unfused particles of the deposited first material, provided by the concavity defining means 320. The apparatus 30 further comprises a second fusing means 352 for fusing at least some of the particles of the second material. The second fusing means 352 comprises a second laser source 364, a second x-y or x-y-z galvo scanner 365 and the laser controller 363. The second laser source 362 may provide second laser beam L2 a spot size between 2 mm and 20 mm. The second laser source 362 is arranged to control thermal gradients and cooling rates for processing materials such as ceramics and alloys to prevent cracking. Suitable laser sources are known in the art. The first fusing means 350 and the second fusing means 352 are arranged such that laser beams L1 and L2 provided by their respective laser sources are not co-axial i.e. off-axis. The first fusing means 350 and the second fusing means 352 are controlled by the controller 357 and synchronised via a handshake mechanism. The second laser beam L2 from the second fusing means 352 is defocused, with the purpose of thermal management to control the thermal gradient and residual stresses. This is useful for melting ceramics (high melting point) or very thin metals, in which distortion may be problematic. The second laser beam L2 may not be on the same spot and can be separated from the main fusion laser beam from the first fusing means 350. The second laser beam L2 does not melt the materials, but heats up the material to manage the thermal distributions over the entire article to balance the heat to reduce distortions and thermal stresses. The apparatus 30 further comprises a heating means 353 for pre-heating the deposited first material or post-heating the formed first part of the layer of the article. The heating means 353 comprises the second fusing means 352 and a heater 366.

### Embodiment 4

FIG. 61 schematically depicts a powder deposition head 300 (Design 2) according to an exemplary embodiment

Particularly, the powder deposition head 300 is for an additive manufacturing apparatus. The powder deposition head 300 comprises a hopper 310 arranged to receive a powder therein. The powder deposition head 300 comprises a nozzle 320, having a passageway 322 therethrough defining an axis A and in fluid communication with the hopper 310. The powder deposition head 300 comprises a first actuator 330 arranged to, in use, vibrate the powder in the hopper 310 and thereby control, at least in part, movement of the powder in the hopper 310 towards the nozzle 320. The powder deposition head 300 comprises a second actuator 340 coupled to the nozzle 320 and arranged to, in use, vibrate the nozzle 320, at least in part, along the axis A and thereby control, at least in part, movement of the powder from the hopper 310 through the passageway 322.

In this way, the powder deposition head 300 deposits, in use, the powder at a relatively more constant (i.e. uniform) deposition rate.

In this example, the powder deposition head 300 comprises an actuatable member 350, coupled to the first actuator 330, arranged to extend towards and/or at least partially into the passageway 322. In this way, agglomeration of the powder in the nozzle tip is reduced. In contrast, Design 1 does not include the actuatable member 350 and agglomeration of the powder in the nozzle tip occurs. It should be understood that the hopper 310, together with the nozzle 320, the first actuator 330 and the actuatable member 350 of Design 2 replace the hopper of Design 1.

During the powder composite material blending process (particularly, metal/polymer and/or polymer/ceramic powder mix), powder agglomeration may occur due to electrostatic charging of the powder, potentially blocking the feeding nozzle and interrupting the printing process. To overcome this problem, a DC vibrating motor 330 having attached thereto a 0.4 mm diameter needle 350 was installed within the powder hopper 310 so that the needle tip extends into the powder feeding nozzle 320, in order to break any powder agglomeration near the tip of the nozzle 320.

FIG. 62 shows photographs of powders that may be deposited using the powder deposition head of FIG. 61. Polymer and reinforcement powders used: (A) Pa11 Nylon powder (B) Aluminium oxide powder (C) soda-line glass powder (D) Cu10Sn copper alloy powder.

### Powders:

PA11 polymer powder supplied by ASPECT, (Aspex-FPA, ASPECT Japan) was selected as the polymeric binder material. Various metallic and ceramic powder materials were utilized as polymer reinforcement fillers. Spherical Cu10Sn copper-alloy powder (Makin Metal Powders Ltd. UK) was selected to enhance polymer thermal conductivity of the composite. Spherical soda-lime powders (Goodfellow, UK) with 90 μm and 30 μm were utilized to enhance polymer compressive strengths. Aluminium oxide (Sigma-Aldrich Co. UK) was used for improving polymer wear resistance. Ground finished 304 stainless steel blocks and FDM printed PA12 blocks (1.75mm nylon 3D Printer Filament, RS Components, UK) with a dimension 25 mm×25 mm×10 mm were both used as the substrate material. The particle morphological characteristics of PA11, Cu10Sn, aluminium oxide and soda-lime glass were examined using optical microscope (Keyence VHX-5000, Keyence (UK) Ltd., Milton Keynes, UK), as shown in FIG. 62.

For PA11 Glass composite, volumetric ratios of 10% and 30% were prepared. For PA11/Al2O3 and PA11/Cu10Sn composite, volumetric ratios of 10%, 30%, 50%, 70% and 90% were prepared respectively. All composite powders were physically mixed and blended with an in-house motor driven rotating powder mixing chamber for more than 5 hours, followed by drying in an oven for 24 h at 130° C. in order to minimize any moisture.

FIGS. 63 to 66 show exampled of functionally graded materials (FGMs), provided using the the powder deposition head of FIG. 61, that cannot be provided using conventional additive manufacturing methods.

### Printing of Horizontal and Vertical Functionally Graded Polymer/Metal Components

FIG. 63 shows photographs of Cu101Sn/PA11 upward functionally graded materials (FGM) provided using the powder deposition head of FIG. 61. FIG. 64 shows photographs of Cu10Sn/PA11 lateral functionally graded materials (FGM) provided using the powder deposition head of FIG. 61.

### Printing of 3D Polymer/Metal and Polymer/Ceramic Hybrid Components

Components consisted of multiple polymer composites with designed material distribution and complex geometry can be printed.

FIG. 65 shows photographs of 80% Cu10Sn—20% PA11 and 30% Al₂O₃—70% Pa11 functionally graded materials (FGM) provided using the powder deposition head of FIG. 61, particularly printed functional polymeric shoe sole structure for tribological applications.

In more detail, FIG. 65 shows a functional polymeric shoe sole structure to improve wear resistance with high thermal stability for tribological applications., with the help of the ultrasonic vibrating powder dispense system, Pa11/Cu10Snand Pa11/Al₂O₃, can be fabricated.

### Demonstration of 3D Printing of Polymer/Metal and Polymer/Ceramic Functionally Graded Component

FIG. 66 shows A) design of the multiple functional turbine blades, B) powder distribution during the printing process, C&D) 3D printed multiple functional motor blades, E) 3-D functionally graded structure, F) a curved metal/polymer structure, provided using the powder deposition head of FIG. 61.

In more detail, FIG. 66 presents polymeric turbine blades with metallic powders as blade reinforcement and ceramic particles to improve the wear resistance of the central column. The design of the turbine blades is shown in FIG. 66 (A). PA11/Cu10Sn composite is utilized as blade reinforcement material and printed as a curved 3-D functionally graded material structure. The central column of the fan is printed with PA11/Al₂O₃. The rest of the motor blade is printed by pure PA11 polymer. FIG. 66 (B) illustrate the powder distribution during the printing process. FIG. 66 (C) and (D) present the printed sample. FIG. 66 (E) and (F) further provide a closer perspective of the curved 3-D FGM structure. The bottom of the blade consisted of PA11/Cu10sn with a volume ratio of 70/30 and increased gradually to 10/90 with the top, showing the printing flexibility of the system.

Although a preferred embodiment has been shown and described, it will be appreciated by those skilled in the art that various changes and modifications might be made without departing from the scope of the invention, as defined in the appended claims and as described above.

In summary, the invention provides a powder deposition head for an additive manufacturing apparatus that deposits, in use, powder at a relatively more constant (i.e. uniform) deposition rate, thereby reducing defects in a formed part.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A powder deposition head for an additive manufacturing apparatus, comprising:
a hopper arranged to receive a powder therein;
a nozzle, having a passageway therethrough defining an axis and in fluid communication with the hopper;
a first actuator arranged to, in use, vibrate the powder in the hopper and thereby control, at least in part, movement of the powder in the hopper towards the nozzle; and
a second actuator coupled to the nozzle and arranged to, in use, vibrate the nozzle, at least in part, along the axis and thereby control, at least in part, movement of the powder from the hopper through the passageway.

2. The powder deposition head according to claim 1, wherein the first actuator is coupled to the hopper.

3. The powder deposition head according to claim 1, wherein the first actuator is within the hopper.

4. The powder deposition head according to claim 1, wherein the first actuator is arranged to vibrate, at least in part, transverse to the axis.

5. The powder deposition head according to claim 1, wherein the first actuator is arranged to vibrate in a frequency range from 20 Hz to 10 GHz.

6. The powder deposition head according to claim 5, wherein the first actuator is arranged to vibrate in a frequency range from 20 kHz to 10 GHz.

7. The powder deposition head according to claim 5, wherein the first actuator is arranged to vibrate in a frequency range from 20 Hz to 20 kHz, preferably from 100 Hz to 10 kHz.

8. The powder deposition head according to claim 1, wherein the first actuator is arranged to vibrate with an amplitude in a range from 0.1 μm to 500 μm.

9. The powder deposition head according previous claim 1, wherein the hopper is arranged to receive the powder therein in an amount from 1 g to 100 g.

10. The powder deposition head according to claim 1, wherein the passageway has an diameter in a range from 0.1 mm to 1.0 mm.

11. The powder deposition head according to claim 1, comprising a powder reservoir in fluid communication with the hopper and vibrationally isolated therefrom, wherein the powder reservoir is arranged to replenish the powder in the hopper.

12. The powder deposition head according to claim 11, wherein the powder reservoir comprises a syringe arranged to replenish the powder in the hopper.

13. The powder deposition head according to claim 1, comprising an actuatable member, coupled to the first actuator, arranged to extend towards and/or at least partially into the passageway.

14. An additive manufacturing apparatus, preferably a selective laser melting apparatus, comprising the powder deposition head according to claim 1.

15. A method of controlling powder deposition using a powder deposition head according to claim 1 for additive manufacturing, comprising preferably selective laser melting, the method comprising:
vibrating the powder in the hopper and thereby controlling, at least in part, movement of the powder in the hopper towards the nozzle; and
vibrating the nozzle, at least in part, along the axis and thereby controlling, at least in part, movement of the powder from the hopper through the passageway.

16. The method according to claim 15, wherein the powder comprises particles having a size in a range from 5 μm to 200 μm.

17. The method according to claim 16, wherein the particles have an irregular shape.

18. The method according to claim 15, wherein the powder has a bulk density in a range from 50 kg/m³ to 5000 kg/m³ .
